(19) United States
(12) Patent Application Publication
(10) Pub. No.: US 2026/0312865 A1
(43) Pub. Date: Oct. 8, 2026

(54) DYNAMIC PROVISIONING OF DEVICES AND SERVICES

(71) Applicant: T-MOBILE INNOVATIONS LLC, Overland Park, KS (US)

(72) Inventors: Henry Pradeep Kumar CYRIL, Bothell, WA (US); Nathan Thomas SMITH, Eureka, MO (US); Neal Michael MURPHY, Bucyrus, KS (US); Janardhan M. THEPPASANDRA, Sammamish, WA (US); Jyot KUMAR, Sammamish, WA (US); Shrivastava Rajesh GOVINDPRASAD, Bothell, WA (US); Manoj LAKUMARAPU, Overland Park, KS (US)

(21) Appl. No.: 19/173,176

(22) Filed: Apr. 8, 2025

(51) Int. Cl. H04L 41/0806; H04L 47/24

(52) U.S. Cl. CPC H04L 41/0806; H04L 47/24

(57) ABSTRACT

A method is provided for dynamically provisioning devices and/or services. The method includes receiving, by a first transaction priority module, a first plurality of transactions. The method includes duplicating the first plurality of transactions at a second transaction priority module. The method includes sorting the first plurality of transactions into a plurality of topics, and each topic may be prioritized relative to each other based a plurality of priority rules. The method includes providing a first transaction of the first plurality of transactions to a first network provisioning engine (NPE) of a first plurality of NPEs that retrieves the first transaction.

### SUMMARY

The present disclosure is directed, in part to systems and methods for dynamically provisioning devices and/or services within a network, substantially as shown and/or described in connection with at least one of the figures, and as set forth more completely in the claims.

Customers and enterprises regularly request provisioning of devices and services within a network. Conventional provisioning systems often leave customers and/or enterprises waiting for hours for a transaction to be completed as a result of conventional provisioning systems’ inability to prioritize transactions, sequence transactions such that additional network provisioning engines (NPEs) may process transactions associated with the same subscriber identifier, and resolve errors and/or outages within the provisioning center rather than by re-trying or holding the transaction by the source of the request, often a storefront or a management platform associated with an enterprise. By incorporating a transaction priority module, transactions may be sorted into topics and the topics may be prioritized. By incorporating a sequencing queue module, transactions may be processed by various NPEs, clusters of NPEs, and/or NPEs of different provisioning centers. By configuring the transaction priority modules to duplicate its transactions at other transaction priority modules, and by configuring the sequencing queue modules to maintain a common database amongst many provisioning centers, each transaction priority module and each sequencing queue module has access to all relevant information across different provisioning centers, enabling an active-active configuration. By incorporating a reprovisioning module, errors at network elements may be quickly resolved by the NPE rather than being re-tried by the source of the request. By communicating transactions impacted by network element outages to a topic of the transaction priority module, the transactions may be immediately processed once the network element comes back online rather than waiting hours for re-processing.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary call flow for an exemplary method for dynamic provisioning of devices and/or services in which implementations of the present disclosure may be employed;

FIG. 4 illustrates a flow diagram of an exemplary method for dynamic provisioning of devices and/or services in which implementations of the present disclosure may be employed;

FIG. 5 illustrates a flow diagram of an exemplary method for dynamic provisioning of devices and/or services in which implementations of the present disclosure may be employed;

FIG. 6 illustrates a flow diagram of an exemplary call flow for an exemplary method for sequencing transactions in which implementations of the present disclosure may be employed;

FIG. 7 illustrates a flow diagram of an exemplary method for sequencing transactions in which implementations of the present disclosure may be employed;

FIG. 8 illustrates a flow diagram of an exemplary method for sequencing transactions in which implementations of the present disclosure may be employed;

FIG. 9 illustrates a flow diagram of an exemplary method for sequencing transactions in which implementations of the present disclosure may be employed;

FIG. 10 illustrates a flow diagram of an exemplary call flow of an exemplary method for resolving errors during provisioning in which implementations of the present disclosure may be employed;

FIG. 11 illustrates a flow diagram of an exemplary method for resolving errors during provisioning in which implementations of the present disclosure may be employed;

FIG. 12 illustrates a flow diagram of an exemplary call flow of an exemplary method for resolving network element outages during provisioning in which implementations of the present disclosure may be employed; and

FIG. 13 illustrates a flow diagram of an exemplary method for resolving network element outages during provisioning in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, customers routinely provision devices and/or services, such as activating a new phone plan, changing data rates, changing plans, adding services, deactivating services and/or plans, and the like. For example, a customer may walk into a storefront, purchase a new cell phone, and may wait for the activation process to be complete prior to taking their new phone home. In this example, various provisioning transactions must be processed for the activation process to be successful. However, customers are routinely left to wait long periods of time for activation or other provisioning transactions to be complete prior to leaving the store, often as a result of inefficient network provisioning systems. Systems and methods to reduce this wait time and improve the utilization of network resources when completing provisioning transactions, are valuable.

Conventionally, provisioning transactions associated with the same subscriber identifier are completed by the same network provisioning engine (NPE) and/or the same cluster of NPEs (e.g., a plurality of NPEs associated with each other). This is to maintain a logical sequence of transactions such that a preliminary transaction and/or preliminary step of a transaction is processed prior to subsequent transactions and/or subsequent steps of the transaction. Further, conventional provisioning systems often follow a strict first-in first-out framework where transactions are not prioritized based on the features of the transaction and/or the context of the transaction. Instead, all transactions associated with the same subscriber ID must be processed by the same NPE or cluster of NPEs such that the sequence of transactions is not impacted. However, such a configuration often results in particular NPEs or clusters of NPEs being overloaded, especially in the context of large batch transactions. As one example, an entity may request the network provider activate 100,000 internet of things (IoT) device plans, and a customer may request to activate a new mobile device. In this example, the 100,000 activation transactions associated with the IoT devices would be completed prior to the activation transaction of the customer waiting at the storefront. Thus, systems and methods enabling more dynamic and efficient provisioning systems are desirable.

Further, conventional provisioning systems often employ an “active hot-standby” configuration, which means at least one primary provisioning center is “active” and one or more secondary provisioning centers are in “hot-standby” such that they are inactive until needed. This setup enables one or more secondary provisioning centers to take over the transaction processing load of one or more primary provisioning centers when one or more components of the primary provisioning center and/or when the complete primary provisioning center fails (e.g., natural disaster, network outage). However, this configuration inefficiently utilizes network resources, as a portion of the hardware and/or software of the one or more secondary provisioning centers is not in use for a majority of the time.

Further, errors that occur during processing and/or outages at downstream network elements traditionally conventionally cause a transaction to be re-tried or held at the source of the request, often at a storefront or a management platform of an enterprise. These downstream network elements are generally responsible for causing the provisioning of devices and/or services specified in the transaction. Such a process requires the transactions be re-sent by the source of the request, and the transactions may await in the queue for processing for hours until completed due to the strict first-in first-out configuration, resulting in increased wait times for customers.

In contrast to conventional solutions and to provide a dynamic approach to processing provisioning transactions, the present disclosure is directed to systems and methods for utilizing a transaction priority module and a sequencing queue module within each provisioning center to efficiently receive, prioritize, and process various provisioning transactions. A first transaction priority module may receive a first plurality of transactions, and a second transaction priority module may receive a second plurality of transactions. The transaction priority modules may each be associated with their own plurality of network provisioning engines (NPEs). The transaction priority module sorts their transactions into topics, which enables the transaction priority module to prioritize some topics over other topics. The first and second pluralities of NPEs retrieve transactions from the transaction priority module and may communicate with a first and second sequencing queue module to authorize a transaction and/or one or more intermediate steps of a transaction, enabling different NPEs to handle various requests rather than just those associated with particular subscriber identifiers.

Further, each of the first and second transaction priority modules duplicate their transactions at each other such that each of them has access to all transactions, across various provisioning centers. Each of the first and second sequencing queue modules provide their sequencing information to a common database such that each sequencing queue module may access all sequencing information, across various provisioning centers. This enables an active-active configuration such that each processing center may process provisioning transactions at all operating times. In the event that a component of and/or an entire processing center fails, the other processing center may process all provisioning transactions due to the duplication by the transaction priority modules and the common database of the sequencing queue modules. Such a configuration enables each provisioning center to concurrently process transactions yet take over more and/or all transactions when another provisioning center fails.

Further, the sequencing queue module may maintain and access sequencing information from the common database to determine whether to authorize processing of transactions by various NPEs. This sequencing information may be maintained across all sequencing queue modules associated with a variety of provisioning centers so that transactions associated with a single subscriber identifier may be processed by different NPEs, different clusters of NPEs, and/or NPEs of different provisioning centers. In aspects, the sequencing queue module may authorize processing of subsequently-sequenced transactions even when one or more steps of a prior-sequenced transaction is not complete, further reducing the wait time of the customer.

Further, the reprovisioning modules of each NPE may quickly correct errors received by the NPE from a network element unable to process the transaction. In aspects, the reprovisioning module may cross-reference the error with a corrective action, which may be implemented by the NPE. As a result, the transaction may be completed without re-sending by the source of the request, further reducing the wait time of the customer and increasing the efficient use of resources during provisioning. Further, the NPE may detect an outage at a particular network element and may communicate transactions impacted by the outage to the transaction priority module for sorting into a topic associated with the network element experiencing the outage. Once the NPE determines the outage is resolved, the NPE may retrieve transactions from the topic, resulting in decreased wait time of the customer, as these transactions are processed more quickly than if they were resubmitted by the source of the request.

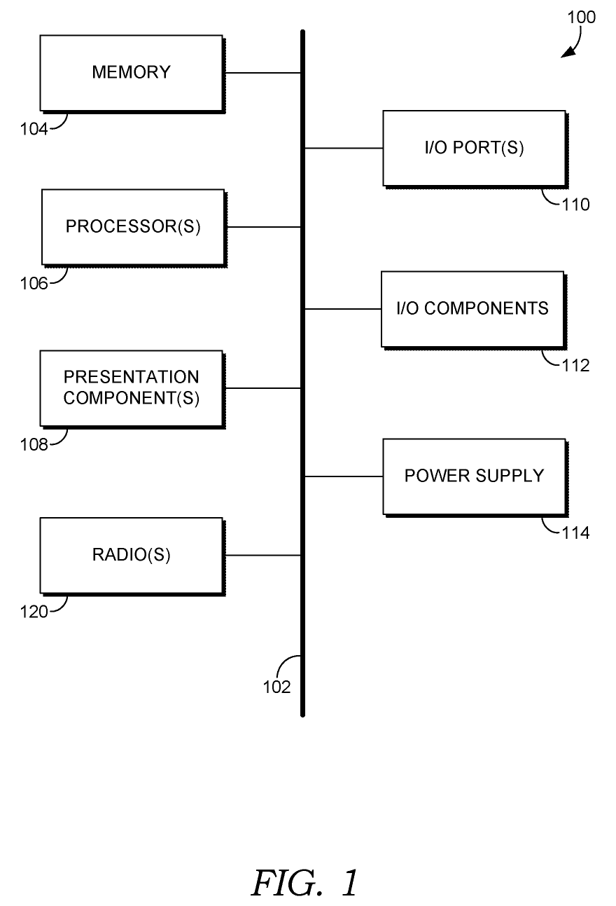

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

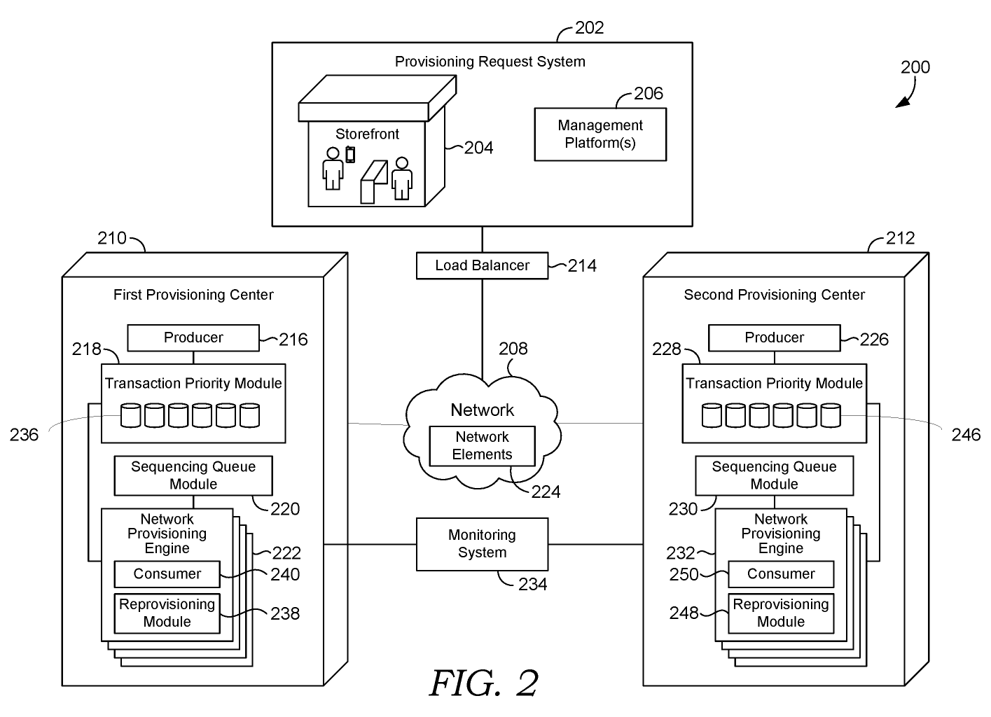

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise a provisioning request system 202, a network 208, a first provisioning center 210, and a second provisioning center 212, though in some implementations, it may not be necessary for certain features to be present. Similarly, while some components are shown in the singular and some components are shown as a plurality, it is expressly contemplated that there may be more or fewer of the components described. For example, while two provisioning centers 210, 212 are illustrated, the systems and methods described herein may be employed in environments where there are four, eight, fifteen, thirty, etc. provisioning centers. The network environment may include a number of routers, switches, and the like. Further, each of the components described herein may take the form of hardware, software, firmware, and the like, including any combination thereof.

The provisioning request system 202, for example, generally receives provisioning requests from various provisioning sources, such as one or more storefronts, such as a storefront 204, one or more management platforms, such as a management platform 206, and the like. As one example, at the storefront 204, a customer may request a provisioning change to their device from an employee associated with the storefront 204. For example, the customer may have purchased a new mobile device and requests to start a network plan for the mobile device. The management platform 206 may be associated with one or more entities that own devices associated with the network operator (e.g., the devices have a mobile network plan with the network operator). These entities may access a management platform, such as the management platform 206, to request provisioning changes similar to how a customer would request provisioning changes at the storefront 204. While the storefront 204 and the management platform 206 are illustrated, fewer or additional sources of provisioning requests may comprise the provisioning request system 202. In aspects, the provisioning request system 202 comprises a billing system. In aspects, the provisioning request system 202 creates provisioning traffic, which includes one or more provisioning requests. Each provisioning request may comprise one or more provisioning transactions. In aspects, each provisioning request may be associated with a brand segment of a plurality of brand segments of the network operator (e.g., prepaid, postpaid, IoT, wholesale).

The load balancer 214, for example, is generally responsible for managing provisioning traffic originating from the provisioning request system 202 by distributing incoming provisioning requests to provisioning centers 210, 212. In aspects, the load balancer 214 receives a plurality of transactions associated with provisioning requests from the provisioning request system 202. In aspects where there are two provisioning centers, such as those shown in FIG. 2, the load balancer 214 distributes about 50% of the provisioning traffic to the first provisioning center 210 and distributes about 50% of the provisioning traffic to the second provisioning center 212. In other aspects, the load balancer 214 may evenly distribute the plurality of transactions among a plurality of provisioning centers. It is expressly contemplated that additional or fewer load balancers are possible. For example, each provisioning center 210, 212 may include its own load balancer to manage internal processing of transactions.

Provisioning requests may be routed through the network 208 from the load balancer 214 to the provisioning centers 210, 212. The network 208 comprises any one or more public or private networks. The network 208 may be configured according to one or more network architectures and/or principles. In some aspects, the network 208 may comprise a cellular telecommunications network (e.g., a 4G, 5G, or 6G core network, an IMS network, and the like) and/or a data network (e.g., LAN, WAN, private enterprise network). In aspects, the provisioning request system 202 may communicate with the network 208 via one or more network nodes, such as via one or more base stations, and/or via one or more wired line connections.

The first provisioning center 210 and the second provisioning center 212 are generally configured to receive and process provisioning requests originating at the provisioning request system 202. The first provisioning center 210 and the second provisioning center 212 include a plurality of components, each of which may be hosted on servers at the provisioning centers 210, 212 and/or take the form of hardware physically present at the provisioning centers 210, 212. Components of the first provisioning center 210 may be modified by the phrase “first” and components of the second provisioning center 212 may be modified by the phrase “second” where applicable herein. In some aspects, the components of the provisioning center 210 are configured to perform the same functions as their corresponding element at the second provisioning center 212, and in other aspects, the components of the provisioning centers 210, 212 are configured to perform differently than their counterparts under certain conditions or scenarios, as will be described herein.

The first provisioning center 210 may generally comprise a producer 216, a transaction priority module 218, a sequencing queue module 220, and a plurality of network provisioning engines (NPEs) 222. The second provisioning center 212 includes at least some of the same components of the first provisioning center 210, such as a producer 226, a transaction priority module 228, sequencing queue module 230, and a plurality of NPEs 232. Each of these components may communicate with each other, directly or indirectly (e.g., via interfaces existing between them). One or more components of the first provisioning center 210 may communicate with one or more components of the second provisioning center 212 via the network 208. Each of the preceding components may take different forms, including consolidated or distributed forms that perform the same general operations. In other architectures or protocols, the components may be given other names, however, the components herein refer to functions, not specifically identified components.

Though the producers 216, 226, the transaction priority modules 218, 228, the sequencing queue modules 220, 230, and the pluralities of NPEs 222, 232 are illustrated within each provisioning center 210, 212, the provisioning centers 210, 212 may have more or fewer components than shown, and some components may be in locations other than within the provisioning centers 210, 212 (e.g., within the network 208, at the network edge). For example, while two transaction priority modules 218, 228 and two sequencing queue modules 220, 230 are illustrated, each provisioning center 210, 212 may, in some aspects, utilize a single shared transaction priority module 218, 228 and/or a single sequencing queue module 220, 230. Each of the preceding components of the provisioning centers 210, 212 may take different forms, including consolidated or distributed forms that perform the same general operations. In other architectures, the components may be given other names, however, the components herein refer to functions, not specifically identified components.

The producers 216, 226, for example, may generally be responsible for generating data and/or providing resources to one or more components of the provisioning centers 210, 212. The producers 216, 226 may create and manage the overarching architecture of the network environment 200 (e.g., setup, maintenance). The producers 216, 226 may validate incoming provisioning transactions (e.g., from the load balancer 214) and ensure compliance with security policies prior to communicating the transactions downstream. In aspects, the producers 216, 226 may communicate with the transaction priority modules 218, 228, such as to communicate the pluralities of provisioning transactions to the transaction priority modules 218, 228.

The transaction priority modules 218, 228, for example, are generally responsible for receiving a plurality of provisioning transactions and for sorting transactions into topics 236, 246 such that the transactions may be prioritized. The transaction priority modules 218, 228 may sort the transactions into the topics 236, 246 based on a number of factors, such as transaction type (e.g., activation, deactivation, plan change), the type of user device associated with the transaction (e.g., personal mobile device, IoT device associated with an enterprise), the origination of the request (e.g., storefronts, such as the storefront 204, management platforms, such as the management platform 206), whether the transaction is part of a batch job (e.g., a plurality of transactions associated with a single request and/or enterprise) and/or is a customer transaction (e.g., associated with a customer at a storefront, such as the storefront 204).

The transaction priority modules 218, 228 may duplicate their transactions with each other such that each transaction priority module 218, 228 has access to all transactions in the event a component of a provisioning center or an entire provisioning center fails. The transaction priority modules 218, 228 may provide transactions from the topics 236, 246 based on priority rules to the pluralities of NPEs 222, 232. The transaction priority modules 218, 228 may be created utilizing a version of Apache Kafka (e.g., version 3.9.0, version 3.8.1).

The sequencing queue modules 220, 230, for example, are generally responsible for authorizing and/or approving requests to process particular transactions and/or steps of the particular transactions. For example, different NPEs of the pluralities of NPEs 222, 232 may retrieve a plurality of transactions, and some transactions may need to occur before others to ensure a proper sequence of transactions is maintained. For example, an “activate” transaction associated with a particular device and/or subscriber must be completed prior to an “add feature” transaction (e.g., voicemail) associated with the particular device.

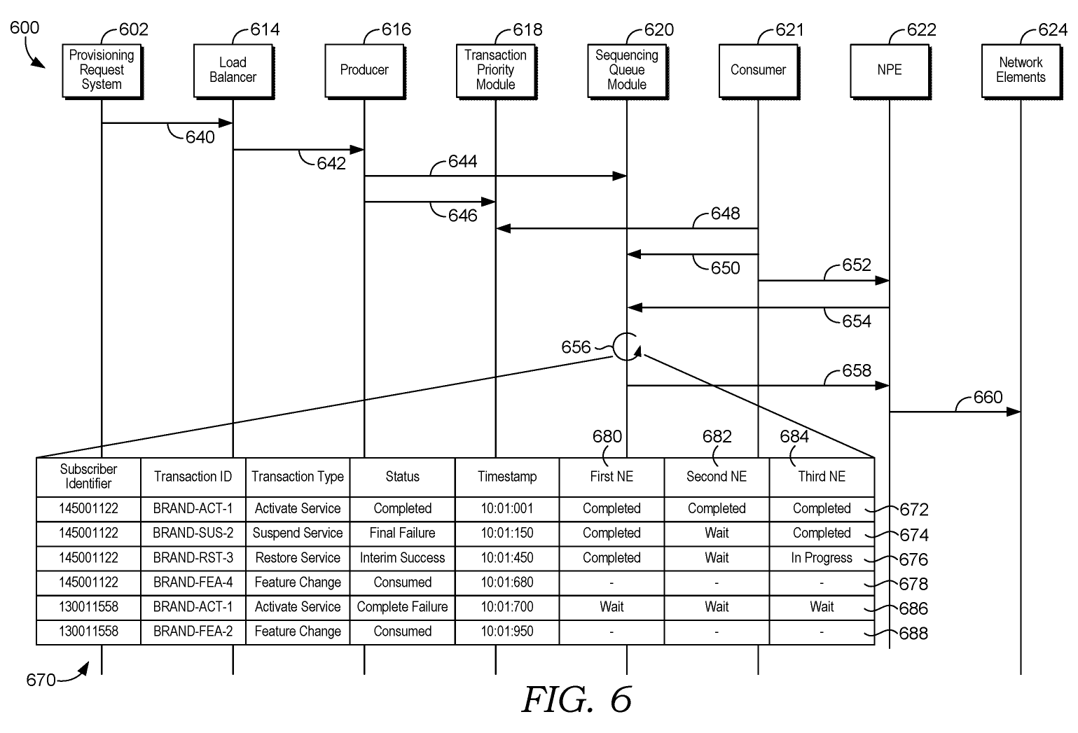

The sequencing queue modules 220, 230 may determine to authorize transactions and/or steps of transactions based on sequencing information, which is described in more detail with respect to FIG. 6. In aspects, the sequencing information includes a timestamp associated with a time in which the transaction was received by one or more components of the provisioning centers 210, 212 (e.g., the producers 216, 226). In aspects, the sequencing information includes the history and status of provisioning transactions associated with particular devices and/or subscribers (e.g., based on subscriber identifier, device ID), which may be maintained across each sequencing queue module 220, 230 (e.g., in the common database). Similar to the transaction priority modules 218, 228, the sequencing queue modules 220, 230 also provide their sequencing information to a common database such that each sequencing queue module 220, 230 has access to all sequencing information across the different provisioning centers 210, 212. The sequencing queue modules 220, 230 may be created using a version of Apache Cassandra (e.g., 5.0, 4.1.8, 4.0.17).

The pluralities of NPEs 222, 232, for example, are generally responsible for provisioning one or more devices and/or services to such devices by processing provisioning transactions. The pluralities of NPEs 222, 232 may retrieve transactions from the transaction priority modules 218, 228, such as from the topics 236, 246. In aspects, at least some of the transactions may be temporarily stored in internal queues of the pluralities of NPEs 222, 232. In aspects, an NPE of the pluralities of NPEs 222, 232 receives a transaction, which may include customer-facing services (i.e., what the provisioning request system 202 is requesting, such as a particular service). In such aspects, the NPE translates the customer-facing services into network-facing services such that the network elements 224 may understand and process the transaction. In aspects, the pluralities of NPEs 222, 232 may access a network provisioning catalog to translate customer-facing services into network-facing services. The pluralities of NPEs 222, 232 may request authorization and/or approval to process a particular transaction and/or step of a particular transaction from the sequencing queue modules 220, 230.

The consumers 240, 250, for example, are each generally associated with one NPE of the pluralities of NPEs 222, 232, and may generally perform one or more functions related to processing transactions. The consumers 240, 250 may retrieve transactions from the transaction priority modules 218, 228, such as from the topics 236, 246, on behalf of the NPE of the pluralities of NPEs 222, 232 (e.g., the transaction is consumed by the consumers 240, 250). The consumers 240, 250 may communicate with the sequencing queue modules 220, 230, such as to provide sequencing information related to transactions being consumed by the consumers 240, 250. The consumers 240, 250 of each NPE of the pluralities of NPEs 222, 232, while illustrated as a subcomponent of NPEs, are configured to communicate with the NPEs of the pluralities of NPEs 222, 232 independently.

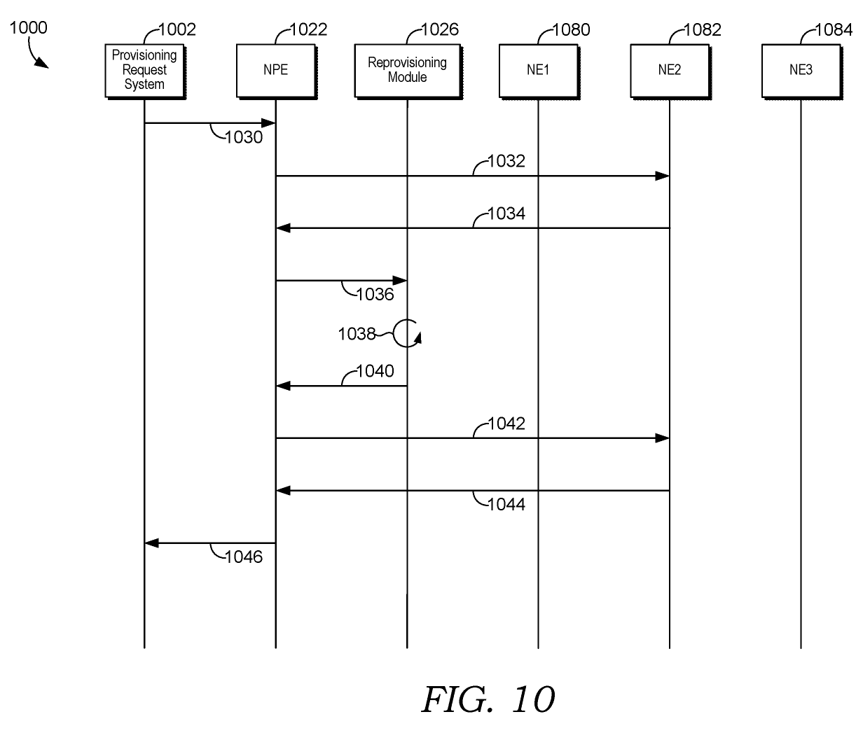

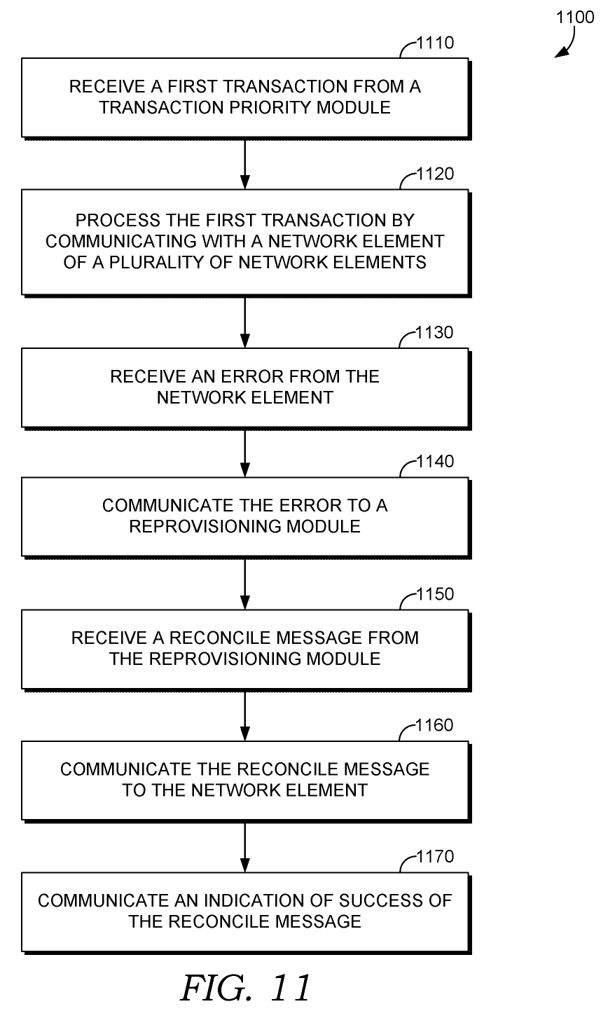

The reprovisioning modules 238, 248, for example, may be generally responsible for correcting errors generated by one or more network elements 224, as will be described in more detail with respect to FIGS. 10-11. For example, the reprovisioning modules 238, 248 may receive an error from an NPE of the pluralities of NPEs 222, 232, and in response, may determine a corrective action. The reprovisioning modules 238, 248 may access a rules database and cross-reference the error to determine the corrective action. The reprovisioning modules 238, 248 of each NPE of the pluralities of NPEs 222, 232, while illustrated as a subcomponent of NPEs, are configured to communicate with the NPEs of the pluralities of NPEs 222, 232 independently.

The monitoring system 234, for example, may generally be responsible for monitoring the function of provisioning centers, such as the provisioning centers 210, 212, and reporting outages or failures to unaffected provisioning centers. The monitoring system 234 may monitor the function and/or performance of each component and/or element of the provisioning centers 210, 212. When the monitoring system 234 detects a failure at a provisioning center, the monitoring system 234 may notify and/or instruct one or more components of an unaffected provisioning center to process the duplicated provisioning transactions of the affected provisioning center (e.g., using the sequencing information in the common database).

Relevant to the present disclosure, user devices (e.g., cell phones, routers, printers), features (e.g., voicemail, data, custom features, APIs), or various configuration settings (e.g., billing limits, quality of service requirements, user interface settings, security policies) may be provisioned by provisioning centers, such as the first provisioning center 210 and the second provisioning center 212. Conventionally, only one provisioning center would be processing a plurality of transactions while the other remained on standby in the event of a failure. However, by utilizing transaction priority modules and sequencing queue modules, such as the transaction priority modules 218, 228 and the sequencing queue modules 220, 230, information may be duplicated and/or shared across one or more components of the provisioning centers such that each may remain active, and upon a failure, an unaffected provisioning center may take over at least some function of the provisioning center experiencing the failure.

Relevant to the present disclosure, provisioning transactions may be prioritized by utilizing transaction priority modules, such as the transaction priority modules 218, 228, and their ability to sort the transactions into topics, such as the topics 236, 246. Conventionally, transactions are processed in a strict first-in first-out approach, which may delay completion of transactions requiring immediate completion in favor of transactions that are not expecting and/or do not require immediate completion. For example, a customer may wish to activate a new device, such as a cell phone, at a storefront, such as the storefront 204, resulting in an “activate” transaction being requested. In this example, 100,000 “deactivate” transactions may be being processed for 100,000 IoT devices for an enterprise that is winding down a sector of their business, which was submitted through a management platform, such as the management platform 206. The “activate” transaction may be queued to occur after all 100,000 “deactivate” transactions are completed. The customer may need to wait hours in some cases before the “activate” transaction is completed and the device is ready for use. By utilizing the transaction priority modules, various transactions awaiting immediate response may be prioritized over transactions not awaiting an immediate response.

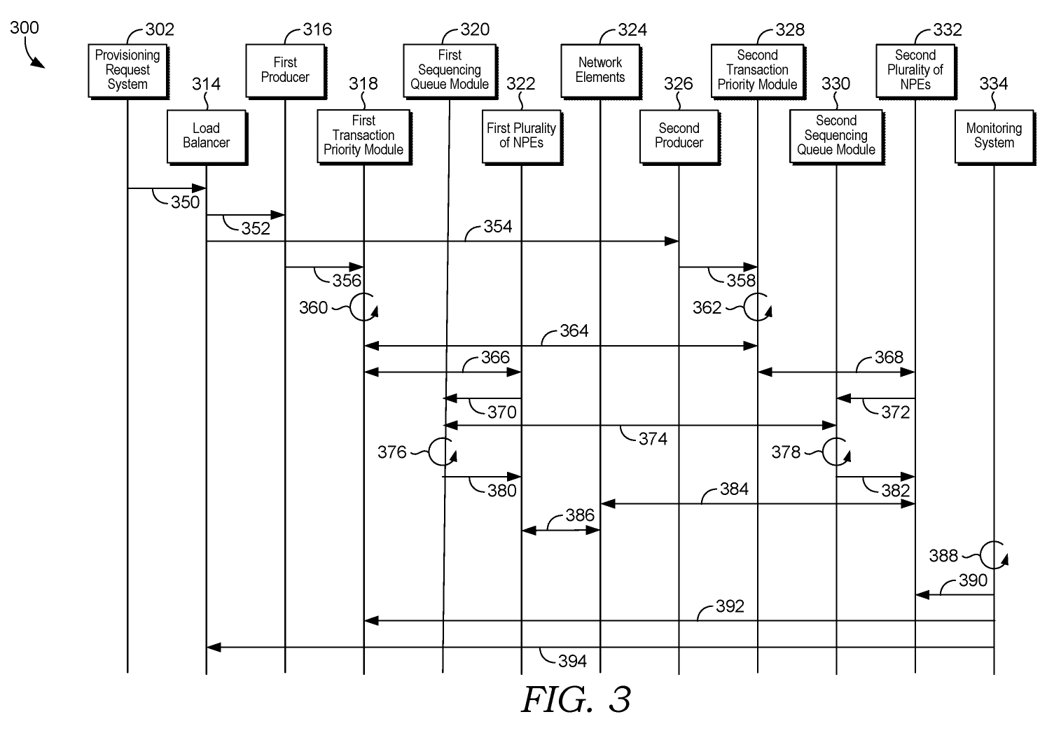

Turning now to FIG. 3, call flow diagram is illustrated in accordance with one or more aspects of the present disclosure and generally reflects systems and methods to dynamically provision devices and/or services. A call flow 300 may be performed by and/or facilitated by one or more components of provisioning centers (e.g., the provisioning centers 210, 212 of FIG. 2). The call flow 300 is not meant to exhaustively show every interaction that would be necessary to practice the invention, so as not to obscure the present disclosure.

The call flow 300 may generally involve a provisioning request system 302 (e.g., the provisioning request system 202 of FIG. 2), a load balancer 314, a first provisioning center (e.g., the first provisioning center 210 of FIG. 2), a second provisioning center (e.g., the second provisioning center 212 of FIG. 2), a plurality of network elements 324 (e.g., the plurality of network elements 224 of FIG. 2), and a monitoring system 334 (e.g., the monitoring system 234 of FIG. 2). The call flow 300 generally illustrates the active-active configuration of the system and how, in the event of a failure, one provisioning center may take over processing for the other experiencing some kind of an outage.

The first provisioning center may include a first producer 316 (e.g., the first producer 216 of FIG. 2), a first transaction priority module 318 (the first transaction priority module 218 of FIG. 2), a first sequencing queue module 320 (e.g., the first sequencing queue module 220 of FIG. 2), and a first plurality of NPEs 322 (e.g., the first plurality of NPEs 222 of FIG. 2). The second provisioning center may include a second producer 326 (e.g., the second producer 226 of FIG. 2), a second transaction priority module 328 (e.g., the second transaction priority module 228 of FIG. 2), a second sequencing queue module 330 (e.g., the second sequencing queue module 230 of FIG. 2), and a second plurality of NPEs 332 (e.g., the second plurality of NPEs 232 of FIG. 2). In aspects, each NPE of the first plurality of NPEs 322 may be associated with one or more clusters of NPEs of the first plurality of NPEs 322, and each NPE of the second plurality of NPEs 332 maybe assigned to one or more clusters of NPEs of the second plurality of NPEs 332. The call flow 300 may include one or more aspects described with respect to FIG. 2. Each of the preceding components may take different forms, including consolidated or distributed forms that perform the same general operations. In other architectures or protocols, the components may be given other names, however, the components herein are described with respect to their functions, not specifically identified components.

At a first step 350, the provisioning request system 302 communicates provisioning requests to the load balancer 314. At the first step 350, the load balancer 314 receives the provisioning requests from the provisioning request system 302. The provisioning request may include various information, such as the type of provisioning requested (e.g., activate device, add service or feature to a device, modify configuration settings), identifiers of the subscriber (e.g., a subscriber identity module (SIM), integrated circuit card identifier (ICCID), international mobile subscriber identity (IMSI), mobile station international subscriber directory number (MSISDN)), whether the request originated at a storefront (e.g., the storefront 204 of FIG. 2) or a management platform (e.g., the management platform 206 of FIG. 2), whether the transaction is a part of a batch job or is a customer transaction, and the like, including any combination thereof. In aspects, at the first step 350, the load balancer 314 receives at least a portion of the provisioning requests generated by the provisioning request system 302. In aspects, the load balancer 314 splits the provisioning requests into about equal portions that may be communicated to other provisioning centers. In aspects, a single provisioning request may include one or more provisioning transactions to be processed by one or more NPEs of the pluralities of NPEs 322, 332.

At a second step 352, the load balancer 314 communicates a first plurality of provisioning transactions to the first producer 316 associated with the first provisioning center, and the first producer 316 receives the first plurality of provisioning transactions. In aspects, the first plurality of transactions comprises about 50% of provisioning traffic associated with the provisioning request system 302. At the first producer 316, the first plurality of provisioning transactions may each be modified to include a timestamp associated with a time in which the transaction was received by the first producer 316.

At a third step 354, the load balancer 314 communicates a second plurality of provisioning transactions to the second producer 326 associated with the second provisioning center, and the second producer 326 receives the second plurality of transactions from the load balancer 314. In aspects, the second plurality of transactions comprise the remaining about 50% of provisioning traffic associated with the provisioning request system 302. At the second producer 326, the second plurality of provisioning transactions may each be modified to include a timestamp associated with a time in which the transaction was received by the second producer 326.

At a fourth step 356, the first producer 316 communicates the plurality of transactions to the first transaction priority module 318, and the first transaction priority module 318 receives the plurality of transactions. At a fifth step 358, the second producer 326 communicates the plurality of transactions to the second transaction priority module 328, and the second transaction priority module 328 receives the plurality of transactions.

At a sixth step 360, the first transaction priority module 318 sorts the first plurality of transactions into a first plurality of topics (e.g., the topics 236 of FIG. 2), and at a seventh step 362, the second transaction priority module 328 sorts the second plurality of transactions into a second plurality of topics (e.g., the topics 246 of FIG. 2). In aspects, the first plurality of topics are the same as the second plurality of topics, and in other aspects, the first plurality of topics are different from the second plurality of topics. The pluralities of topics may function as queues within the transaction priority modules 318, 328. In aspects, the transactions of each topic are queued such that transactions are ordered based on the timestamp at which the transaction was received by the producers 316, 326. Thus, within each topic, the transactions may operate under a first-in first-out approach.

The first and second pluralities of transactions may be sorted into the first and second pluralities of topics based on one or more similarities between transactions. In aspects, transactions may be sorted based on transaction type (e.g., activation, deactivation, plan change, configuration change, billing change). For example, if a first transaction is an activation transaction, the first transaction is sorted into a topic associated with activation transactions. In this example, a second transaction may be a deactivation transaction, and is sorted into a different topic associated with deactivation transactions. The transactions may be sorted based on the type of user device associated with the transaction (e.g., personal mobile device, IoT device associated with an enterprise), the origination of the request (e.g., storefronts, such as the storefront 204, management platforms, such as the management platform 206), whether the transaction is a portion of a batch job (e.g., a plurality of transactions associated with a single request and/or enterprise). In aspects, the transactions may be sorted based on multiple similarities between transactions. For example, a first activation transaction may be sorted into a first topic based on it being associated with a storefront (e.g., the storefront 204 of FIG. 2) and/or being a customer transaction, and a second activation transaction may be sorted in a second topic based on it being associated with a management platform (e.g., the management platform 206 of FIG. 2) and/or a batch job.

At an eighth step 364, the first transaction priority module 318 duplicates the first plurality of transactions at the second transaction priority module 328, and the second transaction priority module 328 duplicates the second plurality of transactions at the first transaction priority module 318. In some aspects, the first transaction priority module 318 duplicates the first plurality of topics at the second transaction priority module 328, and the second transaction priority module 328 duplicates the second plurality of topics at the first transaction priority module 318. The duplication or replication of the first and second pluralities of transactions and/or the first and second pluralities of topics enables each transaction priority module 318, 328 to access to both the first plurality and the second plurality of transactions. In aspects, when one or more components fail and/or an entire provisioning center fails, an unaffected provisioning center, and thus an unaffected transaction priority module, may take over the function of the failed component(s) and/or the effected provisioning center. In aspects, the transaction priority modules 318, 328 duplicate their transactions and/or topics at the other at regular intervals (e.g., every 5 seconds, every 10 seconds, every minute). In aspects, the transaction priority modules 318, 328 are continuously duplicating their transactions and/or topics at the other. The transaction priority modules 318, 328 may store the duplicated transactions and/or topics at a location distinct from that of its own transactions and/or topics. In some aspects, upon a failure of another provisioning center, the transaction priority module 318, 328 may integrate the duplicated plurality of transactions and/or the plurality of topics to its own plurality of transactions and/or plurality of topics.

The pluralities of topics are prioritized relative to each other based on priority rules or principles, which are applied at the topic-level such that some topics are prioritized over others. In some aspects, the first and second pluralities of priority rules are the same, and in other aspects, the first and second pluralities of priority rules are different. The first and second pluralities of priority rules may include assigning a variety of priority levels to topics of the pluralities of topics. In aspects, the priority rules may include assigning additional NPEs and/or clusters of NPEs of the pluralities of NPEs 322, 332 to topics with higher priorities and/or fewer NPEs and/or clusters of NPEs of the pluralities of NPEs 322, 332 to topics with lower priorities. For example, a first topic has a higher priority relative to a second topic, and thus will be assigned additional NPEs and/or clusters of NPEs such that the transactions of the first topic are processed by more NPEs than the transactions of the second topic, effectively prioritizing the first topic and reducing overall processing time of the transactions of the first topic. In aspects, the priority rules may include processing more transactions per unit of time of a first topic and fewer transactions per unit of time of a second topic having a lower priority than the first topic. In aspects, the priority rules may be modified dynamically based on the load of each topic. For example, if a first topic and a second topic have similar priorities (e.g., are assigned a similar amount of NPEs), but the first topic has 12,000 transactions while the second topic has 3,000 transactions, the first topic may be prioritized over the second topic. In this example, as these numbers changed, the priorities of the topics may be modified again.

At a ninth step 366, a first NPE of the first plurality of NPEs 322 (which may be associated with a particular cluster of NPEs of the first plurality of NPEs 322) retrieves one or more transactions from a topic of the first plurality of topics from the first transaction priority module 318. At a tenth step 368, a second NPE of the second plurality of NPEs 332 (which may be associated with a particular cluster of NPEs of the second plurality of NPEs 332) retrieves one or more transactions from a topic of the second plurality of topics from the second transaction priority module 328. In aspects, the retrieved transactions may be retrieved from one or more topics associated with the cluster of the NPE. For example, each NPE may be associated with a cluster, and each cluster may be assigned to one or more topics of the transaction priority modules 318, 328. The retrieved transactions may be stored within internal queues of each NPE, which may be processed in the order in which they were retrieved (e.g., first-in first-out). In aspects, NPEs retrieve the transactions when an available capacity of the internal queue exceeds a pre-determined capacity threshold (e.g., the available capacity of the internal queue is greater than 50%).

At an eleventh step 370, the first NPE of the first plurality of NPEs 322 requests authorization from the first sequencing queue module 320 to process a first transaction, and at a twelfth step 372, a second NPE of the second plurality of NPEs 332 requests authorization from the second sequencing queue module 330 to process a second transaction. In aspects, for purposes of the following discussion, the first transaction is a configuration transaction and the second transaction is an activation transaction. Further, each of the first transaction and the second transaction may be associated with the same subscriber (e.g., the same subscriber ID) and/or the same device (e.g., the same device ID).

At a thirteenth step 374, the first sequencing queue module 320 provides its sequencing information to a common database accessible by a plurality of sequencing queue modules, including the second sequencing queue module 330, as described with respect to FIG. 2. At the thirteenth step 374, the second sequencing queue module 330 provides its sequencing information to the common database such that each sequencing queue module 320, 330 has access to all sequencing information. In some aspects, all the sequencing information may be maintained at the common database accessible by each of the first sequencing queue module 320 and the second sequencing queue module 330. In aspects, the sequencing queue modules 320, 330 may duplicate their sequencing information at regular intervals and/or continuously. In aspects, each sequencing queue module 320, 330 may update the common database with any new information obtained within a last time period.

As will be described in more detail with respect to FIG. 6, at a fourteenth step 376, the first sequencing queue module 320 accesses sequencing information to determine whether to authorize the first transaction. For example, the first transaction may be a configuration transaction, and the first sequencing queue module 320 may determine the subscriber and/or the device associated with the first transaction has not yet been activated. In this example, from this determination, the first sequencing queue module 320 may determine to deny authorization for the first transaction, as the first transaction will fail unless the subscriber and/or device has been activated. At a fifteenth step 378, the second sequencing queue module 330 accesses the sequencing information to determine whether to authorize the second transaction. The second sequencing queue module 330 may determine to authorize the second transaction based on the sequencing information. In aspects, the second sequencing queue module 330 may determine the second transaction is an activation transaction and determine to authorize the second transaction.

At a sixteenth step 380, the first sequencing queue module 320 communicates a rejection to the request for authorization from the first NPE of the first plurality of NPEs 322, and the first NPE of the first plurality of NPEs 322 receives the rejection. In aspects, the first NPE re-submits the request for authorization at regular intervals until the request to process the first transaction is authorized. At a seventeenth step 382 the second sequencing queue module 330 communicates an authorization to the request for authorization from the second NPE of the second plurality of NPEs 332, and the second NPE of the second plurality of NPEs 332 receives the authorization to process the second transaction of the second NPE.

At an eighteenth step 384, the second NPE of the second plurality of NPEs 332 communicates with a plurality of network elements 324 to process the second transaction. As will be described in more detail with respect to FIG. 6, prior to a nineteenth step 386, the first NPE of the first plurality of NPEs 322 may receive authorization from the first sequencing queue module 320 to process the transaction. In aspects, the first NPE of the first plurality of NPEs 322 receives authorization once the second transaction is at least partially completed, as will be described in more detail with respect to FIG. 6. At the nineteenth step 386, the first NPE of the first plurality of NPEs 322 communicates with the plurality of network elements 324 to process the first transaction.

Generally, the components of the call flow 300 will continue to work together to ensure optimal utilization of network resources to quickly and efficiently process provisioning transactions. However, a component of a provisioning center (e.g., a cluster of NPEs of the plurality of NPEs 322, 332, a sequencing queue module 220, 230, a transaction priority module 218, 228) may fail and/or an entire provisioning center may fail (e.g., natural disaster) such that the components of one provisioning center must take over at least a portion of the function of the other. During the course of the call flow 300, the monitoring system 334 may monitor the performance and operability of the various components of the provisioning centers.

At a twentieth step 388, the monitoring system 334 detects a failure, and in response, may notify one or more components of the provisioning centers. In some aspects, the monitoring system 334 detects a partial failure of the second provisioning center (e.g., at least some of the second plurality of NPEs 332 may continue processing transactions with the assistance of one or more components of the first provisioning center). For example, a cluster of NPEs of the second plurality of NPEs 332 may have failed such that they are unable to process one or more topics of the second transaction priority module 328. In another example, the second transaction priority module 328 fails, but the second plurality of NPEs 332 may still process transactions with the assistance of the first transaction priority module 318. In some aspects, the monitoring system 334 detects a total failure of the second provisioning system (e.g., none of the components forming the second provisioning center are able to complete any one or more of the above-described steps with respect to the second provisioning center). For example, the second provisioning center may be hit with a natural disaster.

In aspects where a partial failure occurs due to a failed NPE and/or cluster of NPEs of the second plurality of NPEs 332, at a twenty-first step 390, the monitoring system 334 notifies the second plurality of NPEs 332 of the partial failure and/or instructs any one or more NPEs and/or clusters of NPEs associated with the failure (e.g., are causing the failure) to unsubscribe from all topics at the second transaction priority module 328. In aspects, the cluster of NPEs associated with the failure unsubscribes from the topics based on the notification such that additional transactions do not fail at the cluster of NPEs associated with the failure. In aspects, the monitoring system 334 may instruct the second plurality of NPEs 332 excluding any NPEs and/or clusters of NPEs associated with the partial failure to communicate with one or more components of the first provisioning center, such as the first transaction priority module 318 and/or the first sequencing queue module 320, to continue processing transactions.

In aspects, at a twenty-second step 392, the monitoring system 334 notifies the first transaction priority module 318 of the failure at the second provisioning center. In aspects where the failure is a partial failure, the monitoring system 334 may instruct the first transaction priority module 318 to communicate transactions, such as the second plurality of transactions, to the second plurality of NPEs 332 for processing. In such aspects, the second plurality of NPEs 332 may communicate with the first sequencing queue module 320 to authorize processing of the transactions, or the second plurality of NPEs 332 may communicate with the second sequencing queue module 330, if available (e.g., has not failed). In other aspects, it may be the second sequencing queue module 330 that fails, and the second plurality of NPEs 332 may communicate with the second transaction priority module 328 and the first sequencing queue module 320 to process transactions.

In some aspects, at the twenty-second step 392, where the failure is a partial failure (e.g., at least a portion of the second plurality of NPEs 332 are able to process further transactions with the assistance of one or more components of the first provisioning center), the monitoring system 334 may inform the first transaction priority module 318 to provide each of the first plurality of transactions and the second plurality of transactions to the first and second pluralities of the NPEs 322, 332. In aspects, the first transaction priority module 318 provides the first plurality of transactions to the first plurality of NPEs 322 and provides the second plurality of transactions to the second plurality of NPEs 332. However, in other aspects, such as where the first and second pluralities of topics are the same, the first transaction priority module may integrate the first and second pluralities of topics into one set of topics and/or provide the first and second pluralities of transactions to any of the first and second pluralities of NPEs 322, 332. For example, if a first cluster of NPEs of the first plurality of NPEs 322 is associated with topic 1, and a second cluster of NPEs of the second plurality of NPEs 332 is associated with topic 1, and topic 1 is the same between them, any NPE of the first cluster or the second cluster may process transactions associated with topic 1.

In aspects where the failure is a complete failure (e.g., the second plurality of NPEs 332 are unable to process any further transactions), at the twenty-second step 392, the monitoring system 334 may inform the first transaction priority module 318 to provide the second plurality of transactions to the first plurality of NPEs 322. In some aspects, the first transaction priority module 318 may access the second plurality of topics initially associated with the second transaction priority module 328 to provide the second plurality of transactions to the first plurality of NPEs 322. During a complete failure, the first plurality of NPEs 322 may process at least some of the first plurality of transactions and the second plurality of transactions by communicating with each of the first transaction priority module 318 and the first sequencing queue module 320.

In aspects, at a twenty-third step 394, the monitoring system 334 communicates the failure to the load balancer 314. In aspects, the monitoring system 334 instructs the load balancer 314 to cease communicating transactions to the provisioning center associated with the failure (e.g., cease communicating transactions to the second producer 326 in the call flow 300). In aspects, the load balancer 314, in response to the communication by the monitoring system 334, ceases communicating transactions to the second producer 326 and instead communicates the transactions to the first producer 316.

In aspects, when the failure is resolved, the monitoring system 334 may instruct the load balancer 314 and/or one or more components of the unaffected provisioning center, to resume normal operations (i.e., the active-active configuration), as described with respect to step 350 through step 386 of the call flow 300.

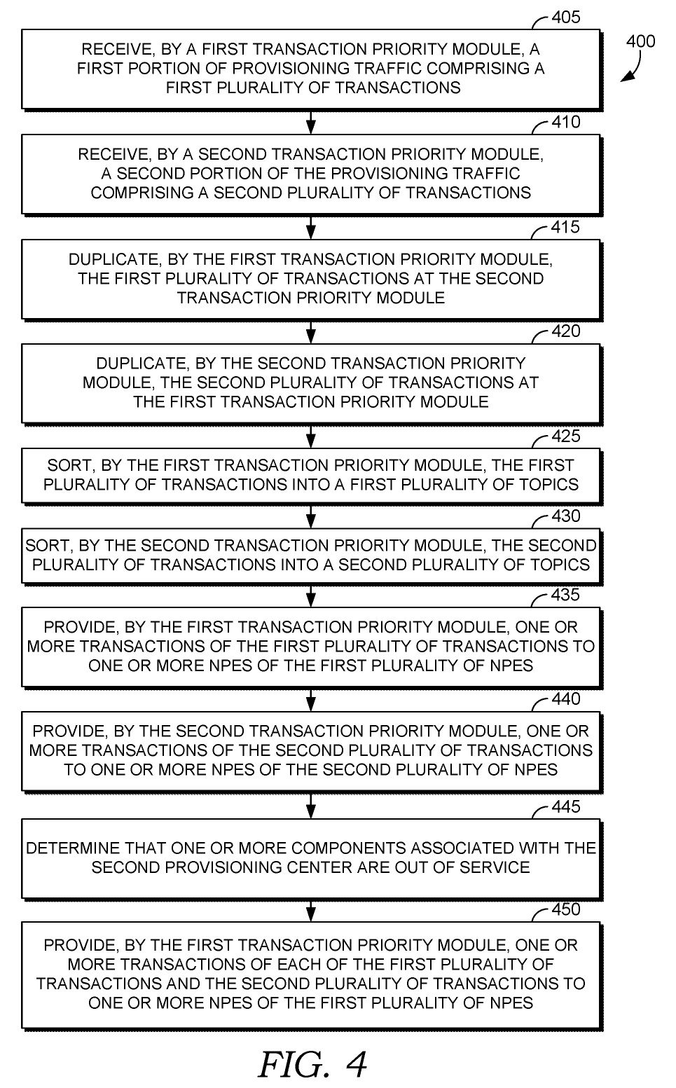

Now referring to FIG. 4, a flow chart is provided that illustrates one or more aspects of the present disclosure relating to a method 400 for dynamically provisioning devices and/or services. The method 400 may include any one or more aspects described with respect to FIGS. 2-3.

At a first step 405, a first transaction priority module (e.g., the first transaction priority module 218 of FIG. 2, the first transaction priority module 318 of FIG. 3) receives a first portion of provisioning traffic comprising a first plurality of transactions, as described above with respect to FIGS. 2-3. The first transaction priority module may be associated with a first provisioning center (e.g., the first provisioning center 210 of FIG. 2). At a second step 410, a second transaction priority module (e.g., the second transaction priority module 228 of FIG. 2, the second transaction priority module 328 of FIG. 3) receives a second portion of the provisioning traffic comprising a second plurality of transactions. The second transaction priority module may be associated with a second provisioning center (e.g., the second provisioning center 212 of FIG. 2).

At a third step 415, the first transaction priority module duplicates the first plurality of transactions at the second transaction priority module, as described with respect to FIGS. 2-3. At a fourth step 420, the second transaction priority module duplicates the second plurality of transactions at the first transaction priority module. At a fifth step 425, the first transaction priority module sorts the first plurality of transactions into a first plurality of topics, as described with respect to FIGS. 2-3. At a sixth step 430, the second transaction priority module sorts the second plurality of transactions into a second plurality of topics. In some aspects, the third step 415 and the fourth step 420 occur before the fifth step 425 and the sixth step 430 such that the pluralities of transactions are duplicated prior to sorting. In other aspects, the first and second pluralities of transactions are sorted into the first and second pluralities of topics prior to duplication of the third step 415 and the fourth step 420 such that the pluralities of topics are duplicated.

At a seventh step 435, the first transaction priority module provides one or more transactions of the first plurality of transactions to one or more NPEs of the first plurality of NPEs, as described with respect to FIGS. 2-3. At an eighth step 440, the second transaction priority module provides one or more transactions of the second plurality of transactions to one or more NPEs of the second plurality of NPEs.

In aspects, one or more components of a provisioning center may be out of service. In aspects, at a ninth step 445, the first transaction priority module determines that the one or more components of the second provisioning center are out of service. In aspects, the first transaction priority module determines this based on a notification originating from a monitoring system (e.g., the monitoring system 234 of FIG. 2, the monitoring system 334 of FIG. 3). In aspects, at a tenth step 450, the first transaction priority module provides one or more transactions of each of the first plurality of transactions and the second plurality of transactions to one or more NPEs of the first plurality of NPEs. In some aspects, the first transaction priority module may provide the transactions of each of the first and second pluralities of transactions to NPEs of each of the first plurality of NPEs or the second plurality of NPEs.

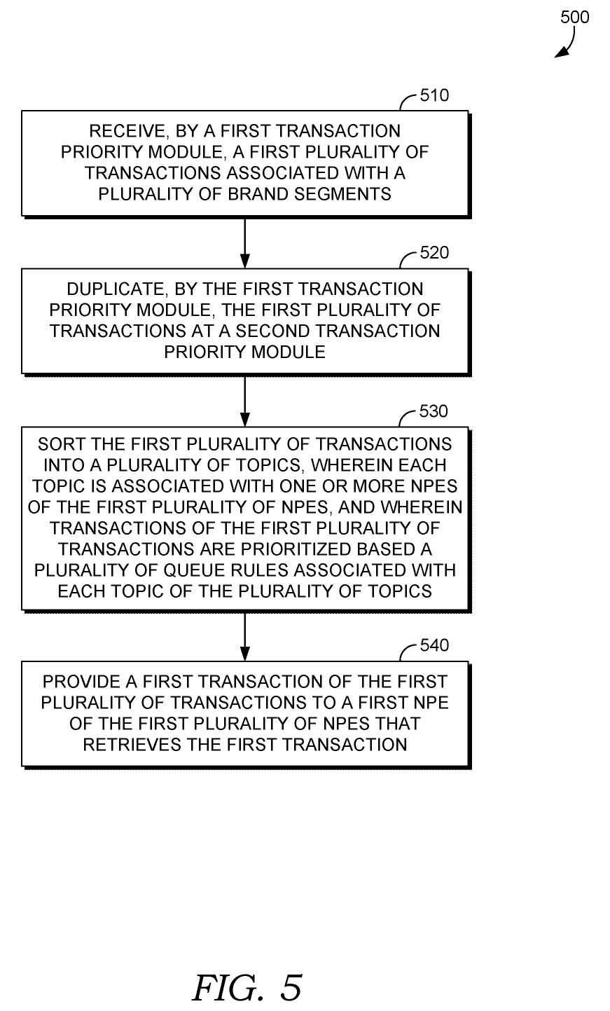

Now referring to FIG. 5, a flow chart is provided that illustrates one or more aspects of the present disclosure relating to a method 500 for provisioning devices and/or services. The method 500 may include any one or more aspects described with respect to FIGS. 2-4.

At a first step 510, a first transaction priority module (e.g., the first transaction priority module 218 of FIG. 2, the first transaction priority module 318 of FIG. 3) receives a first plurality of transactions, as described above with respect to FIGS. 2-3. At a second step 520, the first transaction priority module duplicates the first plurality of transactions at a second transaction priority module (e.g., the second transaction priority module 228 of FIG. 2, the second transaction priority module 328 of FIG. 3).

At a third step 530, the first transaction priority module sorts the first plurality of transactions into a plurality of topics. In aspects, each topic of the plurality of topics is associated with one or more NPEs of the first plurality of NPEs. In aspects, at least some transactions of the first plurality of transactions are prioritized based on a plurality of priority rules associated with the plurality of topics. For example, higher-priority topics may be assigned additional NPEs of the first plurality of NPEs and lower-priority topics may be assigned fewer NPEs of the first plurality of NPEs. At a fourth step 540, the first transaction priority module provides a first transaction of the first plurality of transactions to a first NPE of the first plurality of NPEs that retrieves the first transaction.

Relevant to the present disclosure, the sequence in which steps of transactions and/or the transactions themselves are processed by NPEs (e.g., the pluralities of NPEs 222, 232 of FIG. 2, the pluralities of NPEs 322, 332 of FIG. 3) is maintained by sequencing queue modules (e.g., the sequencing queue modules 220, 230 of FIG. 2, the sequencing queue modules 320, 330 of FIG. 3). Conventionally, transactions associated with the same subscriber identifier are processed at the same NPE and/or at the same cluster of NPEs of the pluralities of NPEs. The NPEs or clusters of NPEs may be assigned to particular groups of subscriber identifiers. For example, NPEs 1-4 are configured to process transactions for subscriber identifiers beginning with “1” and NPEs 5-8 are configured to process transactions for subscriber identifiers beginning with “2.” In this example, some NPEs or clusters of NPEs become overloaded when transactions for subscriber identifiers beginning with “1” outnumber those beginning with “2,” such as in the context of batch transactions, such as where 100,000 IoT devices associated with an enterprise have similar subscriber identifiers. By utilizing a sequencing queue module, NPEs do not need to have such a configuration, and any NPE may process any transaction regardless of the subscriber identifier, reducing and/or eliminating the long wait times experienced by customers. To ensure transactions associated with the same subscriber identifier are processed in the appropriate sequence, the sequencing queue module authorizes transactions and/or steps of transactions based on sequencing information associated with a plurality of transactions associated with the same subscriber identifier.

Now referring to FIG. 6, a call flow diagram is illustrated in accordance with one or more aspects of the present disclosure and generally reflects systems and methods to dynamically provision devices and/or services. A call flow 600 may be performed by and/or facilitated by one or more components of a provisioning center (e.g., the provisioning centers 210, 212 of FIG. 2). The call flow 600 is not meant to exhaustively show every interaction that would be necessary to practice the invention, so as not to obscure the present disclosure.

The call flow 600 may generally involve a provisioning request system 602 (e.g., the provisioning request system 202 of FIG. 2, the provisioning request system 302 of FIG. 3), a load balancer 614 (e.g., the load balancer 214 of FIG. 2, the load balancer 314 of FIG. 3), a first provisioning center (e.g., the first provisioning center 210 of FIG. 2), and network elements 624 (e.g., the network elements 224 of FIG. 2, the network elements 324 of FIG. 3). The call flow 600 generally illustrates a sequencing queue module 620 (e.g., the sequencing queue modules 220, 230 of FIG. 2, the sequencing queue modules 320, 330 of FIG. 3) determining whether to authorize a particular transaction based on sequencing information.

The provisioning center may include a producer 616 (e.g., the producers 216, 226 of FIG. 2), a transaction priority module 618 (the transaction priority modules 218, 228 of FIG. 2, the transaction priority modules 318, 328 of FIG. 3), a sequencing queue module 620 (e.g., the sequencing queue modules 220, 230 of FIG. 2, the sequencing queue modules 320, 330 of FIG. 3), and a plurality of NPEs (e.g., the pluralities of NPEs 222, 232 of FIG. 2, the pluralities of NPEs 322, 332 of FIG. 3). The call flow 600 may include one or more aspects described with respect to FIGS. 2-6. Each of the preceding components may take different forms, including consolidated or distributed forms that perform the same general operations. In other architectures or protocols, the components may be given other names, however, the components herein are described with respect to their functions, not specifically identified components.

At a first step 640, the provisioning request system 602 communicates provisioning traffic to the load balancer 614, and the load balancer 614 receives the provisioning traffic, as described with respect to FIG. 3. The provisioning traffic may comprise a plurality of transactions originating from a storefront (e.g., the storefront 204 of FIG. 2) or a management platform (e.g., the management platform 206 of FIG. 2).

At a second step 642, the load balancer 614 communicates the plurality of transactions to the producer 616, and the producer 616 receives the plurality of transactions, as described with respect to FIG. 3. At the producer 616, the producer captures a timestamp for each transaction of the plurality of transactions associated with a time in which each transaction was received by the producer 616. In aspects, a transaction with an earlier timestamp is communicated to the producer 616 prior to a transaction with a later timestamp.

At a third step 644, the producer 616 communicates the plurality of transactions to the sequencing queue module 620, and the sequencing queue module 620 receives the plurality of transactions. At the sequencing queue module 620, the plurality of transactions may be input into a common database hosting sequencing information. For example, the sequencing queue module 620 may maintain a record of all transactions across provisioning centers. The sequencing queue module 620 may assist in maintaining the common database in which various sequencing information is stored for all transactions, across various sequencing queue modules and/or various provisioning centers. As the sequencing queue module 620 receives information associated with each transaction, the sequencing queue module 620 may update the sequencing information of each transaction.

At a fourth step 646, the producer 616 communicates the plurality of transactions to the transaction priority module 618, and the transaction priority module 618 receives the plurality of transactions, as described with respect to FIG. 3. At the transaction priority module 618, the plurality of transactions may be sorted into a plurality of topics. Various transactions associated with a single subscriber identifier may be sorted in different topics of the plurality of topics based on various similarities among transactions, as described with respect to FIG. 3.

At a fifth step 648, the consumer 621 associated with a particular NPE and/or a particular cluster of NPEs, such as the NPE 622, retrieves a transaction from the transaction priority module 618, and the transaction priority module 618 may provide the transaction to the consumer 621. In some aspects, the consumer 621 retrieves the transaction from a topic of the transaction priority module 618, which the NPE may be assigned to, alone or as a part of a cluster of NPEs. The transaction may be one of multiple transactions associated with a particular subscriber identifier. While the consumer 621 and the NPE 622 are illustrated as distinct components, it is expressly contemplated that the consumer 621 may be one or many components of the NPE 622, as is shown in FIGS. 2-3.

At a sixth step 650, the consumer 621 informs the sequencing queue module 620 that the particular transaction is consumed by the consumer 621, and the sequencing queue module 620 receives a notification that the transaction has been consumed by the consumer 621. In response, the sequencing queue module 620 modifies a status of the transaction. In aspects, the status may indicate the transaction has been retrieved by the consumer 621 and/or the transaction is queued to be processed. At a seventh step 652, the consumer 621 communicates the transaction to the NPE 622, and the NPE 622 receives the transaction. In aspects, the consumer 621 may store the transaction in an internal queue of the NPE 622.

At an eighth step 654, the NPE 622 requests authorization to process the transaction from the sequencing queue module 620, and the sequencing queue module 620 receives a request for authorization to process of the transaction. At a ninth step 656, the sequencing queue module 620 accesses the sequencing information 670 associated with the transaction (e.g., associated a device identifier and/or a subscriber identifier of the transaction). At the ninth step 656, the sequencing queue module 620 may determine to authorize or reject the request to authorize processing of the transaction based on the sequencing information 670 associated with the transaction.

In aspects, the sequencing information 670 generally includes the history and status of provisioning transactions associated with particular devices and/or subscribers (e.g., based on subscriber identifier, device identifier). The sequencing information 670 may include a subscriber identifier, a device identifier, a transaction identifier, a transaction type, a status of each transaction overall, a status of one or more steps of each transaction, and/or any combination thereof. The transaction identifier may include various information such as abbreviations for a brand segment the transaction is associated with, an abbreviation of the transaction type (e.g., ACT for activation, SUS for suspend), a sequence number (e.g., “1” for a first-sequenced transaction for a particular subscriber identifier), and/or any combination thereof.

In aspects, the transaction may comprise one or more primary steps and one or more secondary steps. Primary steps may be considered steps of the transaction that are required to provide core services (e.g., voice services, data services) and secondary steps may be considered steps of the transaction that are required to provide non-core services (e.g., voicemail, SMS). In aspects, secondary steps of a transaction cannot be completed when the primary steps of the transaction fail. Each step may comprise a communication with a particular network element, such as one of the network elements 624. The sequencing information 670 may include a status of one or more steps of the transaction. In aspects, on a transaction step-level, the status may be “in progress,” “completed,” or “wait.” A status of “in progress” indicates an NPE, such as the NPE 622, is working to complete the step of the transaction by communicating with one or more network elements. A status of “completed” indicates the particular step of the transaction has been successfully processed. A status of “wait” indicates the particular step of the transaction has failed and/or will fail, such as a result of an outage at a particular network element. In aspects, a step of a transaction may be “in progress” for a time exceeding a predefined threshold of time (e.g., 1 second, 10 seconds), which causes the “in progress” status to be changed to a “wait” status. In other aspects, the “in progress” status is changed to “wait” based on the NPE 622 receiving an error from a network element.

At a whole-transaction level, the status may be “consumed,” “in progress,” “interim success,” “final failure,” “completed,” and “complete failure,” which may be determined based on the success of processing the one or more primary steps and the one or more secondary steps. A status of “consumed” indicates the transaction has been retrieved by the consumer 621, but processing by the NPE 622 has yet to begin. A status of “in progress” indicates the transaction is being processed, but no one or more steps have either completed or failed. A status of “interim success” indicates the one or more primary steps of the transaction have been successfully completed (e.g., one or more core services have been provisioned), and the one or more secondary steps of the transaction are in progress. A status of “final failure” indicates the one or more primary steps of the transaction have been successfully completed, but one or more secondary steps of the transaction have failed and/or are waiting to be completed (e.g., one or more non-core services have not been provisioned). A status of “completed” indicates the one or more primary steps and the one or more secondary steps of the transaction have been successfully completed (e.g., all core services and non-core services have been provisioned). A status of “complete failure” indicates the one or more primary steps of the transaction have failed (e.g., one or more core services have not been provisioned).

In aspects, the sequencing information 670 includes a timestamp in which the producer 616 received each transaction. In some aspects, the sequencing queue module 620 may authorize a transaction having the earliest timestamp associated with the particular subscriber identifier and/or device identifier, as this indicates the transaction is the first in the sequence. In aspects, the sequencing queue module 620 may authorize to process a transaction having a later timestamp (e.g., occurring after the earliest timestamp associated with the subscriber identifier) when the transaction having the most recent preceding timestamp has the status “completed.”

For purposes of the following example transactions, each transaction may comprise a primary step associated with a first network element 680 and two secondary steps associated with a second network element 682 and a third network element 684. In aspects, any of the following example transactions may be completed by any NPE of any provisioning center (e.g., another NPE within of a cluster of the NPE 622, an NPE within a different cluster of the NPE 622, and/or an NPE associated with a different provisioning center than the NPE 622). Due to the common database accessible by the sequencing queue modules, such as the sequencing queue module 620, as described with respect to FIGS. 2-3, any NPE and/or cluster of NPEs may process any transaction, and the proper sequence is maintained by the sequencing queue module 620 by accessing the sequencing information 670 across various sequencing queue modules.

In a first set of examples, the sequencing queue module 620 may access the sequencing information 670, which at least partially comprises a first transaction 672, a second transaction 674, a third transaction 676, and a fourth transaction 678, each associated with the same subscriber identifier (i.e., 145001122). In aspects, the sequencing queue module 620 may authorize processing of the first transaction 672 based on the timestamp indicating the first transaction 672 is to occur before the second transaction 674 and before the third transaction 676. In some aspects, the sequencing queue module 620 may determine the first transaction 672 is an activation transaction, and may determine to authorize the first transaction 672 based on activation transactions often being the first transaction in a particular sequence, when present. In aspects, the sequencing queue module 620 may access additional information of the sequencing information 670 to determine whether to authorize a later transaction for processing.

In one example, the NPE 622, at the eighth step 654, requests authorization to process the second transaction 674. The sequencing queue module 620 may first determine whether the second transaction 674 is to occur after the first transaction 672, and based on each timestamp, the sequencing queue module 620 determines the second transaction is to occur after the first transaction 672 but before the third transaction 676. The sequencing queue module 620 may subsequently determine whether the overall status and/or the step-level statuses of the first transaction 672 are consistent with authorizing the second transaction 674. The first transaction 672 has the overall status of “completed,” due to the status of the primary step at the first network element 680, the status of the secondary step at the second network element 682, and the secondary step at the third network element 684 each being “completed.” This indicates the core services of the primary step and the non-core services of the secondary steps of the first transaction 672 have been successfully provisioned. Based on the overall status of the first transaction 672 being “completed,” the sequencing queue module 620 determines to authorize processing of the second transaction 674 based on the first transaction 672 having the overall status of “completed.”

In another example, the NPE 622, at the eighth step 654, requests authorization to process the third transaction 676. The second transaction 674 has the status “final failure,” due to the status of the secondary step at the second network element 682 having the status “wait.” Such a status may be caused by an outage at the second network element 682, degradation of the performance at the second network element 682, the NPE 622 receiving an error indicating the secondary step of the second transaction 674, and the like. Because the second network element 682 is associated with a secondary step (e.g., non-core services), the sequencing queue module 620 determines to authorize the third transaction 676 based on the second transaction 674 having the status “final failure.” In this example, the primary step at the first network element 680 of the third transaction 676 may be completed despite the potential failure by the second network element 682 at the secondary step of the second transaction 674. Further, the secondary step at the third network element 684 of the third transaction 676 may be completed due to the secondary step at the third network element 684 of the second transaction 674 being completed. In aspects, the sequencing queue module 620 instructs the NPE 622 to “wait” on the secondary step at the second network element 682 of the third transaction 676 until the secondary step of the second transaction 674 is “completed.”

In another example, the NPE 622, at the eighth step 654, requests authorization to process the fourth transaction 678. The third transaction has the status “interim success” due to the primary step at the first network element 680 being “completed” but the secondary step at the third network element 684 being “in progress.” In this example, once the secondary step at the third network element 684 of the third transaction 676 is “completed,” the overall status of the third transaction 676 will be changed to “final failure.” In some aspects, the sequencing queue module 620 may access the sequencing information 670 and determine the secondary step of the third transaction 676 at the third network element 684 is still “in progress,” and determines to reject authorization to process the fourth transaction 678. The fourth transaction 678 maintains the “consumed” status until the NPE 622 receives authorization to process the fourth transaction 678 and processes at least one step of the fourth transaction 678. In other aspects, the sequencing queue module 620 may determine to authorize processing of the fourth transaction 678 based on the “in progress” status being associated with a secondary step rather than a primary step. In aspects, the NPE 622 may communicate the second transaction 674 and the third transaction 676 to a topic of a transaction priority module until the secondary step at the second network element 682 can be completed, as will be described in more detail with respect to FIG. 10.

In a second set of examples, the sequencing queue module 620 may access the sequencing information 670, which at least partially comprises a fifth transaction 686 and a sixth transaction 688, each associated with the same subscriber identifier (i.e., 130011558), which is a different subscriber identifier than that associated with the first transaction 672, the second transaction 674, and the third transaction 676. The sequencing queue module 620 may authorize processing of the fifth transaction 686 based on the timestamp indicating it is to occur before the sixth transaction 688. The sequencing queue module 620 may authorize processing of the fifth transaction 686 based on the fifth transaction 686 being an activation transaction.

In this example, during processing of the fifth transaction 686, the primary step of the fifth transaction 686 at the first network element 680 may fail, and the sequencing queue module 620 assigns a “wait” status to the primary step of the fifth transaction 686. As a result, the secondary steps of the fifth transaction 686 may be assigned the “wait” status such that the NPE 622 does not immediately process the secondary steps. Due to the failure of the primary step of the fifth transaction 686 at the first network element 680, the fifth transaction 686 may be assigned a “complete failure” status.

In this example, the NPE 622 (or another NPE, as described herein) may request authorization to process of the sixth transaction 688. The sequencing queue module 620 may determine the sixth transaction 688 occurs subsequent to the fifth transaction 686 based on the sixth transaction 688 having a later timestamp than that of the fifth transaction 686. The sequencing queue module 620 may determine, based on the fifth transaction 686 having the “complete failure” status, to reject authorization of processing of the sixth transaction 688. In aspects, the NPE 622 may communicate the fifth transaction 686 and the sixth transaction 688 to a topic of a transaction priority module until the primary step (and the secondary steps) of each transaction may be completed (e.g., the cause of the inability to process the transaction is resolved).

At a tenth step 658, the sequencing queue module 620 communicates an authorization or a rejection to the request to process the transaction to the NPE 622, and the NPE 622 receives a response to the request to process the transaction. In aspects where the sequencing queue module 620 determines to authorize the request to process the transaction, the sequencing queue module 620 may update the status of the transaction from “consumed” to “in progress.” In aspects where the sequencing queue module 620 determines to reject the request to process the transaction, the sequencing queue module 620 does not update the status of the transaction, which may read “consumed,” until the sequencing queue module 620 authorizes the transaction. In aspects, the NPE 622 is configured to regularly re-try (e.g., every 10 milliseconds, every 30 milliseconds) the request to authorize processing of the transaction until the NPE 622 receives authorization to process the transaction.

At an eleventh step 660, once the NPE 622 has received authorization to process the transaction from the sequencing queue module 620, the NPE 622 processes the transaction by communicating with various network elements 624. In aspects, a particular step of the transaction may be associated with a particular network element, as described above with respect to the ninth step 656. The NPE 622 may regularly update the sequencing queue module 620 with the results of each step of the transaction (e.g., primary steps, secondary steps), such that the sequencing queue module 620 may maintain updated status for each transaction, which may be based on one or more status of the one or more primary and secondary steps of the transaction. In aspects, the sequencing queue module 620 may instruct the NPE 622 to communicate results (e.g., any indication of success or failure) of the transaction overall (i.e., whether each step is successful or not), one or more primary steps of the transaction, and/or one or more secondary steps of the transaction, to the sequencing queue module 620 such that the sequencing information 670 is accurate. In other aspects, the NPEs, such as the NPE 622, may be configured to regularly update the sequencing queue module 620 with the results of the transaction, the one or more primary steps, and/or the one or more secondary steps. Based on this information, the sequencing queue module 620 may update the sequencing information to include a status for the transaction overall and/or a status of the one or more steps of the transaction, as described herein with respect to FIG. 6.

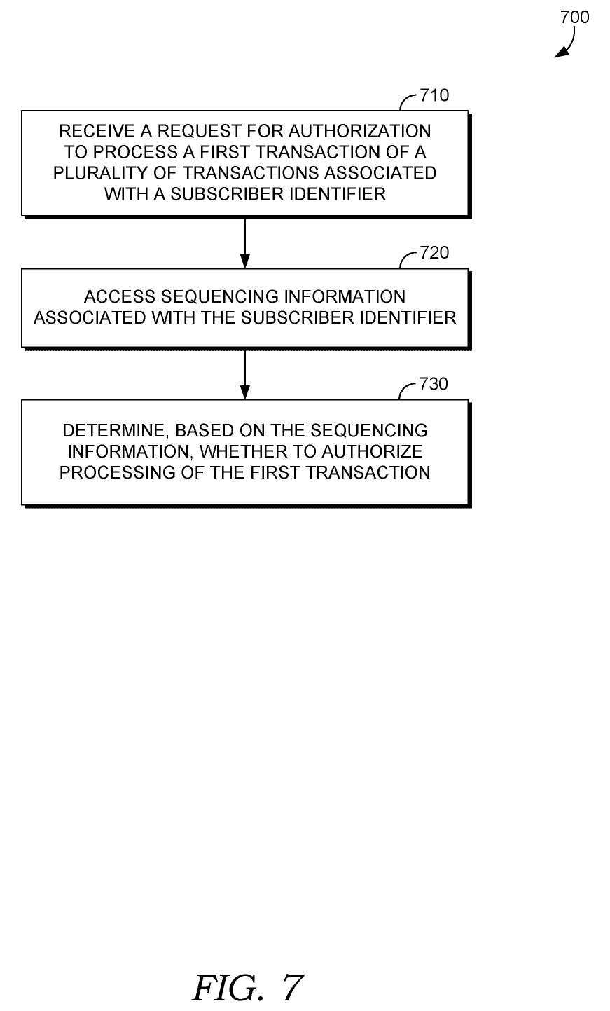

Now referring to FIG. 7, a flow chart is provided that illustrates one or more aspects of the present disclosure relating to a method 700 for sequencing transactions. The method 700 may include any one or more aspects described with respect to FIGS. 2-6.

At a first step 710, a sequencing queue module (e.g., the sequencing queue modules 220, 230 of FIG. 2, the sequencing queue modules 320, 330 of FIG. 3, the sequencing queue module 620 of FIG. 6) receives a request for authorization to process a first transaction of a plurality of transactions associated with a subscriber identifier, as described with respect to FIGS. 2-6. At a second step 720, the sequencing queue module accesses sequencing information (e.g., the sequencing information 670 of FIG. 6) associated with the subscriber identifier. In aspects, the sequencing information is found in a common database including the plurality of transactions associated with the subscriber identifier. In aspects, the sequencing information includes timestamps for each transaction associated with a time in which a producer (e.g., the producers 216, 226 of FIG. 2, the producers 316, 326 of FIG. 3, the producer 616 of FIG. 6) received each transaction. The sequencing information may include one or more statuses of the plurality of transactions associated with the subscriber identifier. The sequencing information may include statuses associated with one or more primary steps of the transaction and statuses associated with one or more secondary steps of the transaction, as described with respect to FIG. 6.

At a third step 730, the sequencing queue module determines, based on the sequencing information, whether to authorize processing of the first transaction. In aspects, when a timestamp of the first transaction is the earliest of the timestamps of the plurality of transactions associated with the subscriber identifier, the sequencing queue module determines to authorize the first transaction. In aspects, when the timestamp of the first transaction is a later timestamp of the timestamps of the plurality of transactions associated with the subscriber identifier, the sequencing queue module determines whether prior-sequenced transactions (based on the timestamp) have a “completed” or “final failure” status or whether they are still “consumed” or an “interim success.” In such aspects, the sequencing queue module may determine to authorize processing where primary steps of the prior-sequenced transaction are successful but one or more secondary steps of the prior-sequenced transaction are not successful (e.g., when the overall status is “final failure”). In aspects, the sequencing queue module may determine to reject processing where one or more primary steps of the prior-sequenced transaction are unsuccessful (e.g., when the overall status is “complete failure”). In aspects, the sequencing queue module may determine to authorize processing where processing the one or more primary steps of the prior-sequenced transaction is successful, and processing of one or more secondary steps of the prior-sequenced transaction are still in progress (e.g., when the overall status is “interim success”). In aspects, the sequencing queue module may determine to reject processing of the transaction where the prior-sequenced

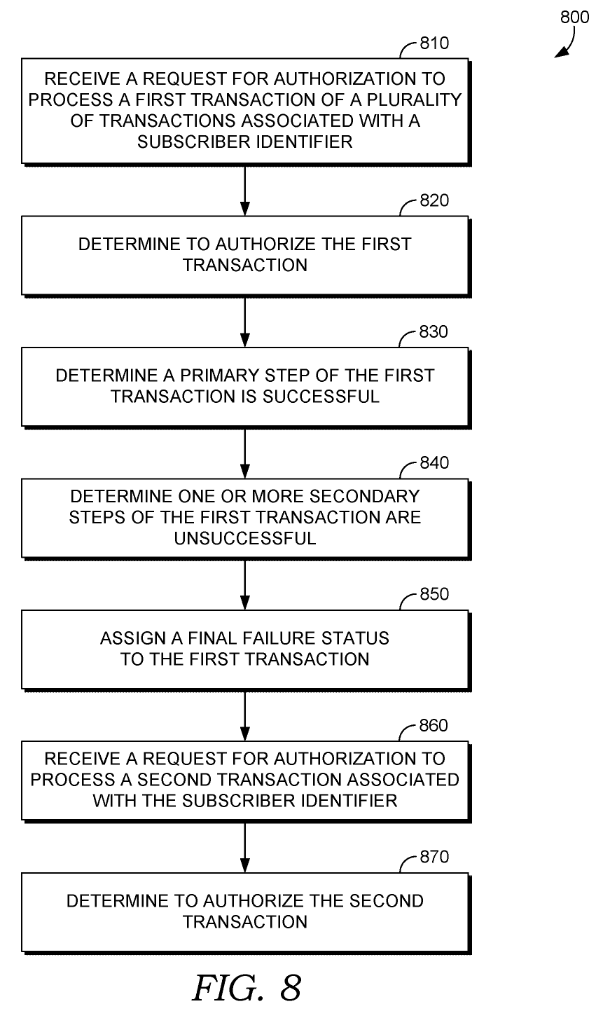

Now referring to FIG. 8, a flow chart is provided that illustrates one or more aspects of the present disclosure relating to a method 800 for provisioning devices and/or services. The method 800 may include any one or more aspects described with respect to FIGS. 2-7.

At a first step 810, a sequencing queue module (e.g., the sequencing queue modules 220, 230 of FIG. 2, the sequencing queue modules 320, 330 of FIG. 3, the sequencing queue module 620 of FIG. 6) receives a request for authorization to process a first transaction of a plurality of transactions associated with a subscriber identifier, as described with respect to FIGS. 6-7. At a second step 820, the sequencing queue module determines to authorize the first transaction. In aspects, the sequencing queue module may determine to authorize the first transaction based on sequencing information, as described with respect to FIGS. 2-7. For example, the sequencing queue module may determine the first transaction is associated with a first timestamp and a second transaction of the plurality of transactions associated with the subscriber identifier is associated with a second timestamp subsequent to the first timestamp. In this example, the sequencing queue module would determine to authorize the first transaction based on the first transaction having an earlier or the earliest timestamp of the plurality of transactions associated with the subscriber identifier.

At a third step 830, the sequencing queue module may determine a primary step of the first transaction is successful. In aspects, the sequencing queue module may assign an “interim success” status to the first transaction based on the primary step of the first transaction being successful and one or more remaining steps of the transaction being “in progress.” At a fourth step 840, the sequencing queue module determines one or more secondary steps of the first transaction are unsuccessful. Based on this determination, at a fifth step 850, the sequencing queue module assigns a “final failure” status to the first transaction overall.

At a sixth step 860, the sequencing queue module receives a request for authorization to process a second transaction associated with the subscriber identifier. In aspects, the second transaction has a timestamp immediately subsequent to the first transaction, indicating the second transaction is to be processed after the first transaction. Based on the “final failure” status, at a seventh step 870, the sequencing queue module may determine to authorize the second transaction. In aspects, the authorization may include instructions to wait on one or more secondary steps associated with the one or more unsuccessful secondary steps of the first transaction.

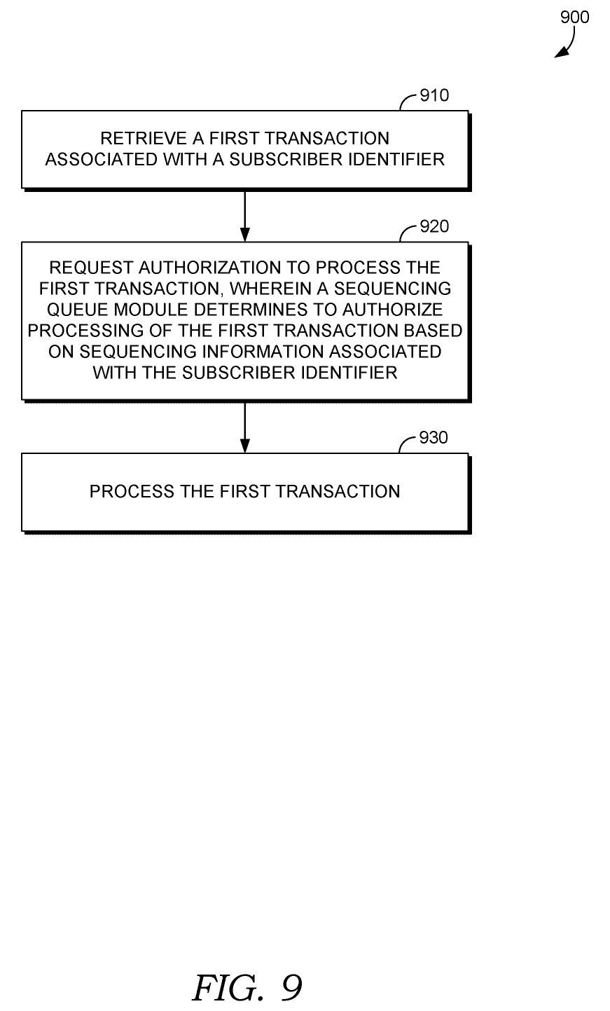

Now referring to FIG. 9, a flow chart is provided that illustrates one or more aspects of the present disclosure relating to a method 900 for sequencing transactions. The method 800 may include any one or more aspects described with respect to FIGS. 2-8.

At a first step 910, an NPE (e.g., an NPE of the first and second pluralities of NPEs 222, 232 of FIG. 2, an NPE of the first and second pluralities of NPEs 322, 332 of FIG. 3, the NPE 622 of FIG. 6) retrieves a first transaction associated with a subscriber identifier. In aspects, a consumer (e.g., the consumers 240, 250 of FIG. 2, the consumer 621 of FIG. 6) of the NPE retrieves the first transaction. In aspects, the NPE retrieves the first transaction from a topic of a transaction priority module (e.g., the transaction priority modules 218, 228 of FIG. 2, the transaction priority modules 318, 328 of FIG. 3, the transaction priority module 618 of FIG. 6). The first transaction may be one of a plurality of transactions associated with the subscriber identifier.

At a second step 920, the NPE requests authorization to process the first transaction. In aspects, a sequencing queue module (e.g., the sequencing queue modules 220, 230 of FIG. 2, the sequencing queue modules 320, 330 of FIG. 3, the sequencing queue module 620 of FIG. 6) determines to authorize processing of the first transaction based on sequencing information associated with the subscriber identifier, as described with respect to FIGS. 6-8. In aspects, the sequencing queue module determines to authorize processing of the first transaction based on one or more of: a first timestamp in which the first transaction as received by a producer (e.g., the producer 216 of FIG. 2, the producer 316 of FIG. 3) and a status of one or more transactions associated with the subscriber identifier. In aspects, the one or more transactions are prior-sequenced transactions that are to occur prior to the first transaction.

At a third step 930, the NPE processes the first transaction. In aspects, the NPE may process one or more primary steps of the first transaction and one or more secondary steps of the first transaction. In aspects, the NPE may communicate the results of the one or more primary steps and the one or more secondary steps to the sequencing queue module, such that the sequencing queue module can accurately make further authorization decisions based on the sequencing information.

Relevant to the present disclosure, provisioning requests may occasionally fail due to a network element (e.g., the network elements 224 of FIG. 2, the network elements 324 of FIG. 3, the network elements 624 of FIG. 6) being unable to locate requisite data or information to complete a step of a transaction (e.g., a primary step, a secondary step). For example, a network element may determine the subscriber associated with the transaction is not registered at the network element such that the subscriber is not found. Conventionally, in this occasional event, the entire transaction must be communicated back to the provisioning request system (e.g., the provisioning request system 202 of FIG. 2, the provisioning request system 302 of FIG. 3, the provisioning request system 602 of FIG. 6) and the request must be re-sent to the provisioning centers with an entire payload including the information necessary to resolve the error at the network element. Further, each step must be processed, or reprocessed for one or more steps, as the entire transaction, including all steps, is re-sent and processed again, despite whether some steps of the transaction were previously successful. In conventional provisioning systems employing strict first-in, first-out, the transaction may take hours of waiting by a customer before the transaction is successfully processed by the network element.

Now referring to FIG. 10, a call flow diagram is illustrated in accordance with one or more aspects of the present disclosure and generally reflects a method for resolving errors during provisioning. A call flow 1000 may be performed by and/or facilitated by one or more components of a provisioning center (e.g., the provisioning centers 210, 212 of FIG. 2). The call flow 1000 is not meant to exhaustively show every interaction that would be necessary to practice the invention, so as not to obscure the present disclosure.

The call flow 1000 generally includes a provisioning request system 1002, an NPE 1022 (e.g., the plurality of NPEs 222, 232 of FIG. 2, the plurality of NPEs 322, 332 of FIG. 3, the NPE 622 of FIG. 6), a reprovisioning module 1026 (e.g., the reprovisioning modules 238, 248 of FIG. 2), a first network element 1080 (e.g., the first network element 680 of FIG. 6), a second network element 1082 (e.g., the second network element 682 of FIG. 6), and a third network element 1084 (e.g., the third network element 684 of FIG. 6) which represent a plurality of network elements (the plurality of network elements 224 of FIG. 2, the plurality of network elements 324 of FIG. 3, the plurality of network elements 624 of FIG. 6). The call flow 1000 may include one or more aspects described with respect to FIGS. 2-9. Each of the preceding components may take different forms, including consolidated or distributed forms that perform the same general operations. In other architectures or protocols, the components may be given other names, however, the components herein are described with respect to their functions, not specifically identified components.

At a first step 1030, the provisioning request system 1002 communicates a transaction, as is described with respect to FIGS. 2-9, and the NPE 1022 may receive the transaction. While not shown, the transaction may be received by a producer (e.g., the producer 216 of FIG. 2, the producer 316 of FIG. 3, the producer 616 of FIG. 6), which may communicate the transaction to a transaction priority module (e.g., the transaction priority modules 218, 228 of FIG. 2, the transaction priority modules 318, 328 of FIG. 3, the transaction priority module 618 of FIG. 6). The transaction priority module may sort the transaction into a topic, as described above with respect to FIGS. 2-5. At the first step 1030, the NPE 1022 receives the transaction (e.g., via a consumer). In aspects, the NPE 1022 retrieves the transaction from the topic of the transaction priority module. In aspects, the NPE 1022 receives an entire payload associated with the transaction, including subscriber information (e.g., name, account number, subscriber identifier), device information (e.g., IMEI, software version, serial number), SIM card details (e.g., ICCID), service plan details (e.g., features included in selected service plan), network information (e.g., IP address, access point name (APN)), authentication credentials (e.g., security tokens, passwords), billing information, and/or the like, including any combination thereof. The entire payload includes the information necessary to resolve any subsequent errors generated by the first network element 1080, the second network element 1082, and/or the third network element 1084.

At a second step 1032, the NPE 1022 communicates a step of the transaction to the second network element 1082. In aspects, the step may be a primary step (e.g., associated with core services), and in other aspects, the step may be a secondary step (e.g., associated with non-core services), as described with respect to FIGS. 6-9. At the second step 1032, the second network element 1082 receives one or more requests associated with the step of the transaction. In aspects, the second network element 1082 may attempt to process the one or more requests associated with the step of the transaction and determine the second network element 1082 is unable complete the one or more requests of the step of the transaction. For example, the second network element 1082 may be unable to complete the step based on the subscriber associated with the transaction and/or other information associated with the subscriber associated with the transaction being unavailable.

At a third step 1034, the second network element 1082 communicates an error to the NPE 1022, and the NPE 1022 receives the error from the second network element 1082. The NPE 1022 may determine that, based on the error, the second network element 1082 is still operating but is unable to complete the particular step of the transaction due to informational limitations. In aspects, the error may reflect the subscriber associated with the transaction and/or other information associated with the subscriber associated with the transaction is unavailable such that the subscriber does not exist at the second network element 1082. The error may include the particular network element in which generated the error, the type of transaction, a time of the failure, and the like, including any combination thereof. At a fourth step 1036, the NPE 1022 communicates the error from the second network element 1082 to the reprovisioning module 1026, and the reprovisioning module 1026 receives the error.

At a fifth step 1038, the reprovisioning module 1026 determines a corrective action to respond to the error. In aspects, the corrective action may be determined based on the error type. The reprovisioning module 1026 may access a rules database to determine the corrective action. In aspects, the reprovisioning module 1026 cross-references the error with a corresponding error type in the rules database. In aspects, the reprovisioning module 1026 determines whether the error requires correction. For example, some errors may reflect that the step of the transaction has occurred already, and no further action is required.

In aspects, the reprovisioning module 1026 determines the error requires a corrective action. At the rules database, the reprovisioning module 1026 may cross-reference the error with a corresponding error type and cross-reference one or more additional features of the step of the transaction. In aspects, the reprovisioning module 1026 further cross-references the network element at which the error originated (e.g., the first network element 1080, the second network element 1082, the third network element 1084), as a response to the error may differ based on the particular network element at which the error originated. In aspects, the reprovisioning module 1026 further cross-references the transaction type associated with the error. For example, the response to the error may differ whether the transaction is an activation transaction, a suspension transaction, an add feature transaction, and the like. Based on the cross-referencing of the error type and/or the one or more additional features of the step of the transaction the rules database provides a corrective action. In aspects, the corrective action includes a request and/or instructions to resolve the error.

At a sixth step 1040, the reprovisioning module 1026 communicates a response to the error to the NPE 1022. In aspects, the reprovisioning module 1026 determines that no corrective action is required and communicates instructions to ignore the error to the NPE 1022. In other aspects, the reprovisioning module 1026 determines corrective action is required and communicates a reconcile message to the NPE 1022 comprising the corrective action (e.g., a request and/or instructions to the second network element 1082 to resolve the error). In aspects, the reprovisioning module 1026 and/or the NPE 1022 inputs information from the entire payload received at the first step 1030 into the reconcile message such that the network element that produced the error may resolve the error. For example, where the error is associated with a subscriber not being registered at the network element, the reconcile message may include the information necessary to register the subscriber at the network element.

At a seventh step 1042, the NPE 1022 communicates the reconcile message to the second network element 1082. The reconcile message may include the corrective action and a request to complete the transaction and/or the step of the transaction. At the second network element 1082, the second network element 1082 may resolve the error based on the reconcile message and complete the step of the transaction. In aspects, the second network element 1082 creates the subscriber at the second network element 1082 and completes the step of the transaction. At an eighth step 1044, the second network element 1082 communicates an indication of success to the NPE 1022. In aspects, the indication of success indicates that the step of the transaction is completed. At a ninth step 1046, the NPE 1022 communicates an indication of success, and the provisioning request system 1002 receives the indication of success. In aspects, the indication of success may pass through one or more components of the provisioning center prior to being received by the provisioning request system 1002.

Now referring to FIG. 11, a flow chart is provided that illustrates one or more aspects of the present disclosure relating to a method 1100 for resolving errors during provisioning. The method 1100 may include any one or more aspects described with respect to FIGS. 2-10.

At a first step 1110, an NPE (e.g., the plurality of NPEs 222, 232 of FIG. 2, the plurality of NPEs 322, 332 of FIG. 3, the NPE 622 of FIG. 6, the NPE 1022 of FIG. 10) receives a first transaction from a transaction priority module (e.g., the transaction priority modules 218, 228 of FIG. 2, the transaction priority modules 318, 328 of FIG. 3, the transaction priority module 618 of FIG. 6), as described above with respect to FIGS. 2-10. In aspects, the NPE retrieves the first transaction from a topic of the transaction priority module. At a second step 1120, the NPE processes the first transaction by communicating with a network element (e.g., the network elements 680, 682, 684 of FIG. 6, the network elements 1080, 1082, 1084 of FIG. 10) of a plurality of network elements (e.g., the plurality of network elements 224 of FIG. 2, the plurality of network elements 324 of FIG. 3, the plurality of network elements 624 of FIG. 6). In aspects, the processing of the first transaction comprises processing a step of the first transaction.

At a third step 1130, the NPE receives an error from the network element during processing the transaction, as described with respect to FIG. 10. At a fourth step 1140, the NPE communicates the error to a reprovisioning module (e.g., the reprovisioning modules 238, 248 of FIG. 2, the reprovisioning module 1026 of FIG. 10), and the reprovisioning module receives the error from the NPE. The reprovisioning module may access a rules database to locate an error type associated with the error. The reprovisioning module may further locate a transaction type and/or the particular network element associated with the error. The reprovisioning module may determine a corrective action based on the error type, the transaction type, and/or the particular network element associated with the error. The reprovisioning module may generate a reconcile message and communicate the reconcile message to the NPE, as described above with respect to FIG. 10.

At a fifth step 1150, the NPE receives a reconcile message from the reprovisioning module, as described above with respect to FIG. 10. In aspects, the reconcile message includes a request and/or instructions for the network element to resolve the error. The reconcile message may further include the initial request to complete processing of the transaction, such as instructions to complete the step of the transaction. At a sixth step 1160, the NPE communicates the reconcile message to the network element. In aspects, the NPE subsequently receives an indication of success from the network element, which may indicate resolution of the error and/or completion of processing of the transaction and/or the step of the transaction. At a seventh step 1170, the NPE communicates an indication of success of the transaction and/or the step of the transaction to a provisioning request system (e.g., the provisioning request system 202 of FIG. 2, the provisioning request system 302 of FIG. 3, the provisioning request system 602 of FIG. 6, the provisioning request system 1002 of FIG. 10).

Relevant to the present disclosure, conventionally, when a network element fails due to an outage localized to a particular network element, various transactions may be halted such that they are not processed in a timely manner. The provisioning request system may receive an error for the transaction and hold the transaction for future reprovisioning, such as at a storefront or management platform, based on a determination that the particular network element is out of service. Conventionally, all subsequently sequenced transactions would be halted until the outage is resolved and the previous transaction is completed. This may result in customers waiting hours before the outage is resolved and their new device and/or one or more features are provisioned. By incorporating the transaction priority module, transactions and/or steps of transactions may be held at the provisioning center, allowing immediate reprovisioning once the outage is restored. Further, by incorporating a sequencing queue module, later-sequenced transactions may proceed where only a secondary step of a prior-sequenced transaction is unable to be completed due to an outage.

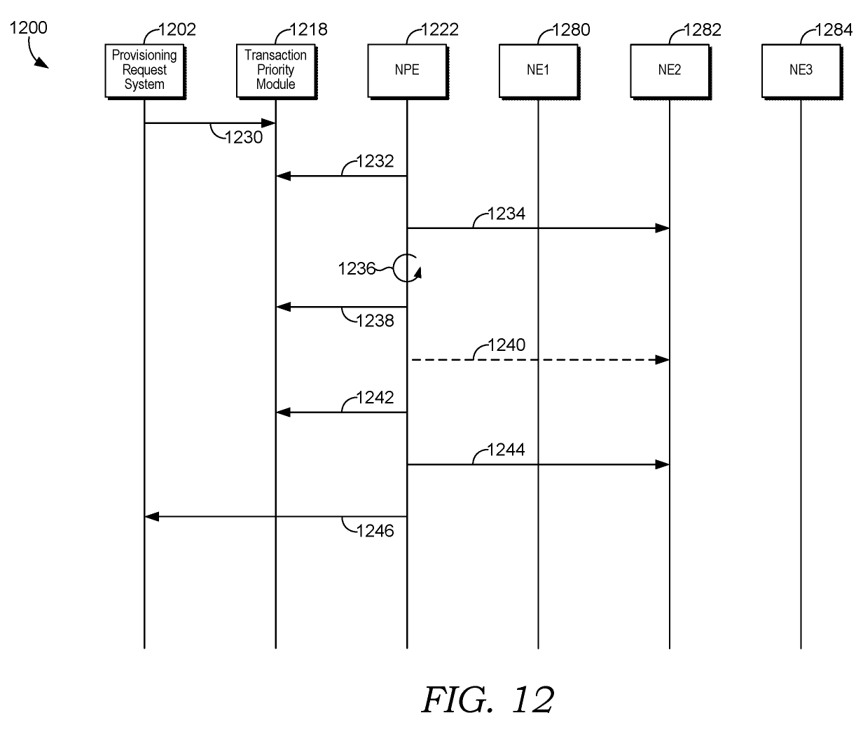

Referring now to FIG. 12, a call flow diagram is illustrated in accordance with one or more aspects of the present disclosure and generally reflects a method for resolving network element outages during provisioning. A call flow 1200 may be performed by and/or facilitated by one or more components of a provisioning center (e.g., the provisioning centers 210, 212 of FIG. 2). The call flow 1200 is not meant to exhaustively show every interaction that would be necessary to practice the invention, so as not to obscure the present disclosure.

The call flow 1200 generally includes a provisioning request system 1202 (e.g., the provisioning request system 202 of FIG. 2, the provisioning request system 302 of FIG. 3, the provisioning request system 602 of FIG. 2, the provisioning request system 1002 of FIG. 10), a transaction priority module 1218 (e.g., the transaction priority modules 218, 228 of FIG. 2, the transaction priority modules 318, 328 of FIG. 3, the transaction priority module 618 of FIG. 6), an NPE 1222 (e.g., the plurality of NPEs 222, 232 of FIG. 2, the plurality of NPEs 322, 332 of FIG. 3, the NPE 622 of FIG. 6, the NPE 1022 of FIG. 10), a first network element 1280 (e.g., the first network element 680 of FIG. 6, the first network element 1080 of FIG. 10), a second network element 1282 (e.g., the second network element 682 of FIG. 6, the second network element 1082 of FIG. 10), and a third network element 1284 (e.g., the third network element 684 of FIG. 6, the third network element 1084 of FIG. 10), which may be representative of a plurality of network elements (e.g., the plurality of network elements 224 of FIG. 2, the plurality of network elements 324 of FIG. 3, the plurality of network elements 624 of FIG. 6). The call flow 1200 may include one or more aspects described with respect to FIGS. 2-11. Each of the preceding components may take different forms, including consolidated or distributed forms that perform the same general operations. In other architectures or protocols, the components may be given other names, however, the components herein are described with respect to their functions, not specifically identified components.

At a first step 1230, the provisioning request system 1202 communicates a transaction, and the transaction priority module 1218 receives the transaction, as described herein. In aspects, the transaction is one of a plurality of transactions associated with a subscriber identifier. In aspects, the provisioning request system 1202 may communicate the transaction to a load balancer (e.g., the load balancer 214 of FIG. 2, the load balancer 314 of FIG. 3, the load balancer 614 of FIG. 6), which communicates the transaction to the transaction priority module 1218. The transaction may comprise one or more primary steps and/or one or more secondary steps. The transaction priority module may sort the transaction into a first topic, as described herein.

At a second step 1232, the NPE 1222 retrieves the transaction from the transaction priority module 1218, such as from the first topic of the transaction priority module 1218. In aspects, the NPE 1222 receives authorization from a sequencing queue module (e.g., the sequencing queue modules 220, 230 of FIG. 2, the sequencing queue modules 320, 330 of FIG. 3, the sequencing queue module 620 of FIG. 6) to process the transaction and/or a step of the transaction. In such aspects, the sequencing queue module determines to authorize the transaction and/or the step of the transaction based on sequencing information, as described with respect to FIGS. 2-9. At a third step 1234, the NPE 1222 processes the transaction and/or one or more steps of the transaction by communicating with the second network element 1282.

At a fourth step 1236, the NPE 1222 determines the second network element 1282 is out of service. In aspects, the NPE 1222 makes this determination based on a duration of time passing from the communication of the third step 1234 occurring without receiving a response from the second network element 1282. In aspects, the NPE 1222 makes this determination based on receiving an out of service error from the second network element 1282.

In some examples, a primary step of the transaction is impacted by the outage of the second network element 1282. In aspects, the NPE 1222 may update the sequencing queue module of the failure at the second network element 1282, and the sequencing queue module may update the sequencing information (e.g., the sequencing information 670) to include a status of “wait” for the primary step of the transaction waiting to be completed by the impacted network element and a status of “complete failure” for the transaction overall, as described with respect to FIGS. 6-9. In this example, any subsequently-sequenced transaction may be denied for processing based on the prior-sequenced transaction (e.g., based on an earlier timestamp) having the status “complete failure,” as described with respect to FIGS. 6-9. In this example, any subsequently-sequenced transaction may remain in the internal queue of an NPE or be communicated to the second topic of the transaction priority module 1218.

In some examples, a secondary step of the transaction is impacted by the impacted network element, the second network element 1282. In aspects, the sequencing queue module may update the sequencing information may include a status of “wait” for the step of the transaction waiting to be completed by the impacted network element and a status of “final failure” for the transaction overall, as described with respect to FIGS. 6-9. In aspects, the sequencing queue module may determine to authorize processing of subsequently-sequenced transactions with instructions to wait for the step of the transaction associated with the second network element 1282.

In aspects, at a fifth step 1238, the NPE 1222 communicates the transaction and/or the step of the transaction to the transaction priority module 1218. At the transaction priority module 1218, the transaction and/or the step of the transaction is sorted into a second topic. The second topic may be associated with transactions and/or steps of transactions waiting to be completed by the impacted network element. In other aspects, the transaction and/or the step of the transaction may be stored in an internal queue of the NPE 1222.

At a sixth step 1240, the NPE 1222 may communicate a heartbeat to the second network element 1282. In aspects, the heartbeat comprises a message configured to illicit a response from the second network element 1282. In aspects, the heartbeat may be configured based on which particular network element is impacted by the outage. The NPE 1222 may regularly (e.g., every 500 ms, every second, every minute, and the like) communicate the heartbeat to the second network element 1282. In aspects, the NPE 1222 may determine the second network element 1282 is operational based on the NPE 1222 receiving a response to the heartbeat from the second network element 1282. In aspects, the provisioning request system 1202 may request a processing status from the NPE 1222, and the NPE 1222 may provide a processing status to the provisioning request system 1202. In aspects, the processing status indicates whether the second network element 1282 is out of service or whether the second network element 1282 is operational. In aspects, the processing status may further include sequencing information (e.g., the sequencing information 670 of FIG. 6), such as whether a particular transaction and/or step of the transaction is successful, still waiting, is in-progress, and the like, as described with respect to FIGS. 6-9.

In aspects, at a seventh step 1242, the NPE 1222 retrieves the transaction and/or the step of the transaction from the transaction priority module 1218 based on the determination that the second network element 1282 is operational. In some aspects, the NPE may retrieve the transaction from its own internal queue. In aspects, the NPE 1222 retrieves the transaction and/or the step of the transaction from the second topic of the transaction priority module 1218. In aspects, the priority of the second topic may be adjusted based on a number of transactions in the second topic exceeding a pre-determined threshold. For example, if there are over 1,000 transactions at the second topic, the second topic may be prioritized over one or more other topics, as described with respect to FIGS. 3-5.

At an eighth step 1244, the NPE 1222 processes the transaction and/or the step of the transaction by communicating with the second network element 1282. In some aspects, the transaction and/or the step of the transaction may be processed, and the sequencing information updated such that subsequently-sequenced transactions and/or subsequently-sequenced steps of the transaction may proceed. At a ninth step 1246, the NPE 1222 communicates an indication of success to the provisioning request system 1202. In aspects, the indication of success is communicated via any one or more components described herein (e.g., consumer, load balancer).

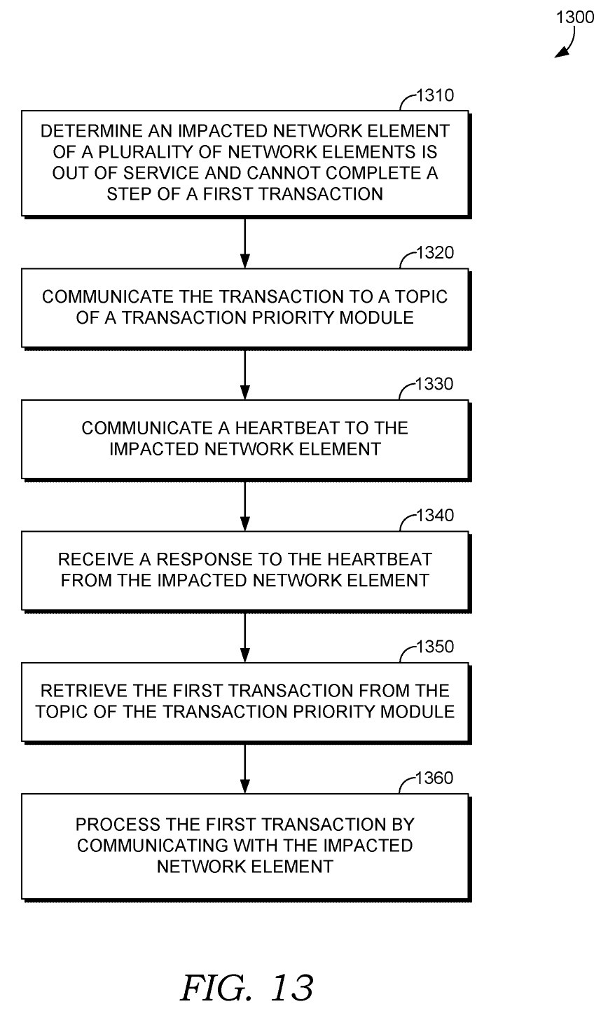

Now referring to FIG. 13, a flow chart is provided that illustrates one or more aspects of the present disclosure relating to a method 1300 for resolving network element outages during provisioning. The method 1300 may include any one or more aspects described with respect to FIGS. 2-12.

At a first step 1310, an NPE (e.g., the plurality of NPEs 222, 232 of FIG. 2, the plurality of NPEs 322, 332 of FIG. 3, the NPE 622 of FIG. 6, the NPE 1022 of FIG. 10, the NPE 1222 of FIG. 12) determines an impacted network element (e.g., the second network element 1282 in FIG. 12) of a plurality of network elements (e.g., the plurality of network elements 224 of FIG. 2, the plurality of network elements 324 of FIG. 3, the plurality of network elements 624 of FIG. 6, the network elements 1080, 1082, 1084 of FIG. 10, the network elements 1280, 1282, 1284 of FIG. 12) is out of service and cannot complete a first transaction, as described with respect to FIG. 12.

At a second step 1320, the NPE communicates the first transaction to a topic of transaction priority module (e.g., the transaction priority modules 218, 228 of FIG. 2, the transaction priority modules 318, 328 of FIG. 3, the transaction priority module 618 of FIG. 6, the transaction priority module 1218 of FIG. 12), as described above with respect to FIGS. 2-12. The topic of the transaction priority module may be associated with transactions and/or steps of transactions that have failed at the impacted network element and/or would fail at the impacted network element (e.g., are associated with a step at the impacted network element).

At a third step 1330, the NPE communicates a heartbeat to the impacted network element. In aspects, the NPE may regularly communicate the heartbeat to the impacted network element until the NPE receives a response to the heartbeat from the impacted network element, as described with respect to FIG. 12. In aspects, where a primary step of the transaction is waiting at the topic of the transaction priority module, any requests to authorize processing of subsequently-sequenced transactions will be rejected. In such aspects, the subsequently-sequenced transactions may remain in the internal queue of the NPE or the subsequently-sequenced transactions may be communicated to the topic of the transaction priority module.

At a fourth step 1340, the NPE receives a response to the heartbeat from the impacted network element and determines the impacted network is operational. In aspects, at a fifth step 1350, the NPE receives the first transaction from the topic of the transaction priority module, as described with respect to FIG. 12. At a sixth step 1360, the NPE processes the first transaction by communicating with the impacted network element, as described with respect to FIG. 12.

We claim:

1. A method for dynamically provisioning devices and/or services, the method comprising:
receiving, by a first transaction priority module of a first provisioning center, a first portion of provisioning traffic comprising a first plurality of transactions, wherein the first transaction priority module is associated with a first plurality of network provisioning engines (NPEs);
receiving, by a second transaction priority module of a second provisioning center, a second portion of the provisioning traffic comprising a second plurality of transactions, wherein the second transaction priority module is associated with a second plurality of NPEs;
duplicating, by the first transaction priority module, the first plurality of transactions at the second transaction priority module;
duplicating, by the second transaction priority module, the second plurality of transactions at the first transaction priority module;
sorting, by the first transaction priority module, the first plurality of transactions into a first plurality of topics, wherein each topic is prioritized relative to other topics of the first plurality of topics based on a first plurality of priority rules;
sorting, by the second transaction priority module, the second plurality of transactions into a second plurality of topics, wherein each topic is prioritized relative to other topics of the second plurality of topics based on a second plurality of priority rules;
providing, by the first transaction priority module, one or more transactions of the first plurality of transactions to one or more NPEs of the first plurality of NPEs;
providing, by the second transaction priority module, one or more transactions of the second plurality of transactions to one or more NPEs of the second plurality of NPEs;
determining that one or more components associated with the second provisioning center are out of service; and
providing, by the first transaction priority module, the one or more transactions of each of the first plurality of transactions and the second plurality of transactions to the one or more NPEs of the first plurality of NPEs.

2. The method of claim 1, wherein the first plurality of topics is the same as the second plurality of topics.

3. The method of claim 1, wherein the first plurality of priority rules is the same as the second plurality of priority rules.

4. The method of claim 1, wherein one or more of the first plurality of priority rules and the second plurality of priority rules comprise assigning fewer NPEs to lower-prioritized topics and assigning more NPEs to higher-prioritized topics.

5. The method of claim 4, wherein at least one of the higher-prioritized topics comprise customer transactions and wherein the lower-prioritized topics comprise batch transactions.

6. The method of claim 1, wherein the determining that the second transaction priority module is caused by a monitoring system notifying the first transaction priority module that the one or more components associated with the second provisioning center are out of service.

7. The method of claim 1, wherein the first plurality of transactions and the second plurality of transactions are not assigned to the one or more NPEs based on subscriber identifiers associated with the first plurality of transactions and the second plurality of transactions.

8. A system for dynamically provisioning devices and/or services, the system comprising:
one or more computer processing components configured to perform operations comprising:
receive, by a first transaction priority module, a first plurality of transactions, wherein the first transaction priority module is associated with a first plurality of network provisioning engines (NPEs);
receive, by a second transaction priority module, a second plurality of transactions, wherein the second transaction priority module is associated with a second plurality of NPEs;
sort, by the first transaction priority module, the first plurality of transactions into a first plurality of topics, wherein each topic is prioritized relative to other topics of the first plurality of topics based on a first plurality of priority rules;
sort, by the second transaction priority module, the second plurality of transactions into a second plurality of topics, wherein each topic is prioritized relative to other topics of the second plurality of topics based on a second plurality of priority rules;
duplicate, by the first transaction priority module, the first plurality of topics at the second transaction priority module;
duplicate, by the second transaction priority module, the second plurality of topics at the first transaction priority module;
providing, by the first transaction priority module, one or more transactions of the first plurality of transactions from a first topic of the first plurality of topics to one or more NPEs of the first plurality of NPEs assigned to the first topic; and
provide, by the second transaction priority module, one or more transactions of the second plurality of transactions from a second topic of the second plurality of topics to one or more NPEs of the second plurality of NPEs assigned to the second topic.

9. The system of claim 8, wherein the first plurality of topics is the same as the second plurality of topics.

10. The system of claim 8, wherein the first plurality of transactions and the second plurality of transactions are not retrieved by the one or more NPEs based on subscriber identifiers associated with the first plurality of transactions and the second plurality of transactions.

11. The system of claim 8, wherein the first plurality of transactions are sorted into the first plurality of topics based on a transaction type of each transaction.

12. The system of claim 8, wherein the first plurality of transactions are sorted into the first plurality of topics based on whether a transaction originates at a storefront or at a management platform.

13. The system of claim 8, wherein the first topic of the first plurality of topics is associated with activation transactions and the second topic of the first plurality of topics is associated with deactivation transactions, wherein the first topic is associated with more NPEs of the first plurality of NPEs than the second topic.

14. A method for dynamically provisioning devices and/or services, the method comprising:
receiving, by a first transaction priority module, a first plurality of transactions associated with a plurality of brand segments, wherein a first plurality of network provisioning engines (NPEs) are associated with the first transaction priority module of a first provisioning center;
duplicating, by the first transaction priority module, the first plurality of transactions at a second transaction priority module, wherein a second plurality of NPEs are associated with the second transaction priority module of a second provisioning center;
sorting the first plurality of transactions into a plurality of topics, wherein each topic is associated with one or more NPEs of the first plurality of NPEs, and wherein transactions of the first plurality of transactions are prioritized based a plurality of priority rules associated with the plurality of topics; and
providing a first transaction of the first plurality of transactions to a first NPE of the first plurality of NPEs that retrieves the first transaction.

15. The method of claim 14, wherein the second transaction priority module receives a second plurality of transactions associated with the plurality of brand segments, and wherein the second transaction priority module duplicates the second plurality of transactions at the first transaction priority module.

16. The method of claim 14, further comprising receiving a second plurality of transactions duplicated from the second transaction priority module.

17. The method of claim 16, wherein one or more components of the second provisioning center is out of service, and wherein the first transaction priority module provides one or more of each of the first plurality of transactions and the second plurality of transactions to the one or more NPEs of the first plurality of NPEs associated with the first transaction priority module.

18. The method of claim 14, wherein the first transaction priority module sorts each of the first plurality of transactions and a second plurality of transactions associated with the second transaction priority module into the plurality of topics.

19. The method of claim 14, wherein each topic of the plurality of topics is associated with a particular transaction type.

20. The method of claim 14, wherein the plurality of priority rules comprises assigning fewer NPEs of the first plurality of NPEs to lower-prioritized topics and assigning more NPEs of the first plurality of NPEs to higher-prioritized topics.
